(19) United States
(12) Patent Application Publication
(10) Pub. No.: US 2025/0354930 A1
(43) Pub. Date: Nov. 20, 2025

(54) IONIC LIQUID ENCAPSULATION OF NIR DYES FOR THE IMPROVEMENT OF BLOODSTAIN DETECTION

(71) Applicant: University of Mississippi, University, MS (US)

(72) Inventors: Eden Elizabeth Louise Tanner, Oxford, MS (US); Donovan Seth Darlington, Oxford, MS (US); Will Edward Meador, Oxford, MS (US); Jared Heath Delcamp, Oxford, MS (US)

(21) Appl. No.: 19/207,461

(22) Filed: May 14, 2025

Related U.S. Application Data
(60) Provisional application No. 63/648,706, filed on May 17, 2024.

(51) Int. Cl. G01N 21/64

(52) U.S. Cl. CPC G01N 21/6428; G01N 2021/6439

(57) ABSTRACT

In one aspect, the disclosure relates to compositions comprising an ionic liquid and a near infrared (NIR) dye. In some aspects, the ionic liquid can be choline glycolate with the cation and anion present in a 1:1 ratio and the NIR dye can be SO₃SQ. Also disclosed are methods of making the compositions and methods of using the compositions to positively identify substances as blood. In one aspect, the compositions are shelf-stable, do not damage DNA present in suspected bloodstains, and are highly specific for human blood.

### CROSS REFERENCE TO RELATED APPLICATIONS

This application claims the benefit of U.S. Provisional Application No. 63/648,706 filed on May 17, 2024 which is incorporated herein by reference in its entirety.

### STATEMENT REGARDING FEDERALLY SPONSORED RESEARCH OR DEVELOPMENT

This invention was made with government support under grant number 1757220 awarded by the National Science Foundation. The government has certain rights in the invention.

### BACKGROUND

There is a pressing need to rapidly and accurately determine the presence of serological fluids on objects in a crime scene setting. In particular, blood is implicated in many violent crimes, including assault, homicide, and rape. Blood is a complex fluid that contains a diversity of components, including plasma containing serum proteins (55%), red blood cells (<45%), white blood cells (<1%) and platelets (<0.1%). With the development of trace DNA amplification and subsequent genetic analysis of bloodstains on recovered samples, including textiles such as sheets, clothing items, and furniture, accurate location of blood in situ is increasingly important. A failure to accurately detect trace or latent blood on objects of interest means that subsequent DNA analysis of the samples is impossible and critical information is lost. The loss of DNA data has an enormous impact on the criminal justice system, possibly resulting in an inability to identify or convict the perpetrator(s), or misidentification of the perpetrator(s).

Currently, the luminol test is the most widely-used presumptive bloodstain test across private, state, and national forensics labs. Luminol functions by chemiluminescing in the presence of blood due to an oxidation reaction that is catalyzed by the heme iron of hemoglobin in the presence of an oxidizing agent such as hydrogen peroxide under basic conditions.

3-aminophthalhydrazide, known as luminol, is the most widely used presumptive positive test for blood in a potential or confirmed crime scene. The iron centers in hemoglobin act as catalysts to induce the oxidation of luminol into an excited state that undergoes intersystem crossing to relax and emit photons (Scheme 1).

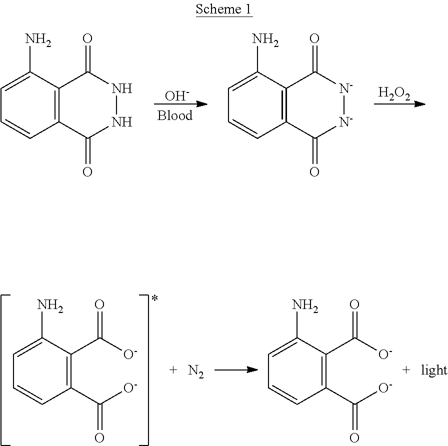

Chemiluminescence of luminol is catalyzed by the iron in the heme of blood.

However, there are a number of problems with the use of luminol as a presumptive test. The chemiluminescent oxidation process can be triggered by a number of agents, including bleach, horseradish and other vegetable matter, and feces. Second, the luminescence is short lived, occurring for 20-30 seconds on average. Third, the emitted light is best observed in a dark environment, making it incompatible for analyses in bright ambient light, such as outdoors. Last, it primarily reacts with surface layer materials and investigators may miss any blood that has seeped into fabric. In addition to all of these limitations, newer cleaning products (marketed as “active oxygen”) are capable of completely circumventing the luminol test because the active ingredient (usually hydrogen peroxide) disfigures the hemoglobin in the red blood cells to such an extent that it can no longer catalyze luminol oxidation. Furthermore, conditions and reagents required by the luminol test may damage DNA present in suspected bloodstains, thereby limiting the information that can be gained during forensic investigations.

Other presumptive positive tests for blood include BlueStar, phenolphthalein (Kastle-Meyer), benzidine (Adler), O-tolidine, tetramethylbenzidine (TMB), hemastix, hematrace, and leuco-malachite green testing. In all of these cases, the hemoglobin catalyzes a reaction with hydrogen peroxide resulting in a color change which makes these tests subject to similar weaknesses to luminol in cleaned crime scenes.

Albumin is the most abundant protein in blood serum and, therefore, makes an ideal target for sensing blood. NIR-emitting dyes are garnering a lot of attention due to their uniquely high emission output in a spectral region with relatively few biological species absorbing light, which can be exploited for biosensing and bioimaging. Small molecule organic fluorophores that emit in the NIR are advantageous in that they result in increased resolution of internal biological systems due to decreased scattering and absorption of NIR light; some undergo a sharp increase in fluorescence quantum yield (Φ_{F}) upon an interaction with specific biomolecules and demonstrate biocompatibility with important blood proteins and nucleic acids. Recently, a NIR emissive sulfonate indolizine-donor-based squaraine dye (SO₃SQ) was observed to exhibit a remarkably intense fluorescence quantum yield (Φ_{F} of 58%) in the presence of fetal bovine serum. A further increase in Φ_{F} to 61.1% was observed when SO₃SQ was dissolved in human serum albumin (HSA). An investigation of this phenomenon revealed that the source of the enhancement was the interaction between the dye and the heme cleft site of albumin, where the dye was locked into an “ultrabright” configuration. However, SO₃SQ is noticeably less fluorescent in whole blood compared to in a solution containing pure albumin protein, likely due to the highly complex microenvironment in the blood matrix.

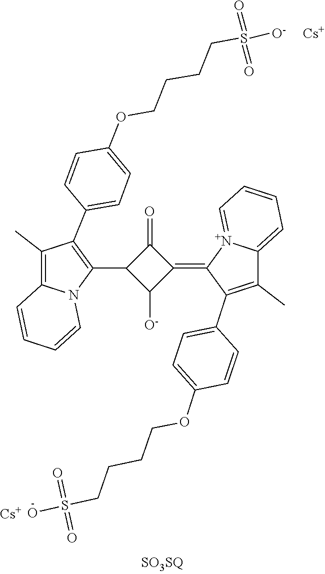

Ionic liquids (ILs) are a class of compounds that are viscous salts at less than 100° C. or, in many cases, at room temperature. They consist of asymmetric cations and anions and are extremely tunable for use in a variety of applications, including catalysis, antimicrobials, nucleic acid research, drug delivery, and biosensing. They have numerous beneficial properties, including thermal stability, inherent conductivity, and tunability, where their bulk properties can be finely controlled by manipulation of their chemical structures. In addition to this, when they are prepared from materials found within the body, or from ingredients that have already been approved by the Federal Drug Administration for therapeutic purposes or as food or cosmetics additives, they have a high degree of biocompatibility. There has been a swath of research conducted on the interaction of ILs with various proteins, including albumin, although many of these were conducted with ILs present in large amounts as solvents rather than in smaller amounts as additives. These previous investigations experimentally examined changes in the protein's structure when interacting with the ILs and utilized Molecular Dynamics (MD) simulations to gain insight into the strength of the IL/albumin interactions. It was determined that ILs containing an imidazolium cation caused domain I in HSA to favor a more unfolded state, while the IL containing a cholinium cation allowed HSA to maintain a stability similar to when it is in an aqueous solution. More recent research involving imidazolium-based ILs and HSA revealed that the percentage of cation binding to the protein was dependent upon the chain length of the imidazolium cation. Tunability of cholinium-based ILs in binding to HSA has not been fully explored.

Therefore, despite many advancements in the analysis of blood samples within the laboratory, more technology to enhance the initial detection of latent serological samples is urgently needed. An ideal technology would be selective for blood samples and would exhibit fluorescence on longer time scales (>1 hour). In addition, an ideal method would not destroy DNA. The method would further be designed to interact with a non-heme component of the blood to ensure that detection is possible even after the application of newly developed cleaning products. An ideal method would exhibit a signal significantly above background levels for any component used therein in the absence of blood. These needs and other needs are satisfied by the present disclosure.

### SUMMARY

In accordance with the purpose(s) of the present disclosure, as embodied and broadly described herein, the disclosure, in one aspect, relates to compositions comprising an ionic liquid and a near infrared (NIR) dye. In some aspects, the ionic liquid can be choline glycolate with the cation and anion present in a 1:1 ratio and the NIR dye can be SO₃SQ. Also disclosed are methods of making the compositions and methods of using the compositions to positively identify substances as blood. In one aspect, the compositions are shelf-stable, do not damage DNA present in suspected bloodstains, and are highly specific for human blood.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C show SO₃SQ dye shows switch-on fluorescence in the presence of blood that is enhanced 5-fold in the presence of 160 mM IL. Fluorescence scans of 10 μM dye in the (FIG. 1A) presence of blood and (FIG. 1B) absence of blood as the concentration of IL is varied from 0 (green solid line), 40 (gray dashed line), 80 (blue solid line), 120 (purple solid line), 160 (red solid line), 200 (navy dashed line), and 240 mM (black solid line) of IL in water. (FIG. 1C) The fluorescent emission of 10 μM SO3SQ (no IL) in the absence (green line) and presence of blood (blue line) contrasts with the emission in the presence of 160 mM IL in the absence (purple) and presence (red line) of blood.

FIG. 2 shows CG (160 mM, 1:1) allows for a greater binding affinity between SO₃SQ and HSA. Normalized fluorescence intensity as a function of albumin concentration was used to compare the binding affinities of a solution of 10 μM SO₃SQ (black) and a solution of 160 mM CG (1:1) in 10 μM SO₃SQ to HSA (red).

FIGS. 3A-3D show the addition of SO₃SQ, CG 1:1, or a combination of the two, to a solution of HSA causes a decrease in the fluorescence of the tryptophan residue. (FIG. 3A) The structure of HSA with location of tryptophan residue; Fluorescence spectra of tryptophan residues under 3 conditions: (FIG. 3B) HSA in water (blue) with the addition of 160 mM CG (1:1) (green); (FIG. 3C) HSA in 10 μM SO3SQ (black) with the addition of 160 mM CG (1:1) (red); (FIG. 3D) HSA in solutions containing 160 mM CG (1:1) (black) prior to adding SO3SQ (purple).

FIGS. 4A-4E show the components of the IL/dye system show a greater binding affinity for the heme cleft. Results of the Molecular Dynamics simulation for complexes of SO₃SQ and glycolate with HSA within (FIG. 4A) heme cleft, (FIG. 4B) Sudlow's site I, (FIG. 4C) Sudlow's site II, (FIG. 4D) site near R485, and (FIG. 4E) results of MM/GBSA calculation for the ligand-albumin complex after MD simulation and trajectory clustering.

FIGS. 5A-5B show proximity of the glycolate anion to W214 results in interactions that lead to quenching of the W214 fluorescence. Superposition of ligand-protein complexes: (FIG. 5A) superimposed protein structures with backbone illustrated as a curved line; (FIG. 5B) superimposed W214 residue.

FIGS. 6A-6B show the presence of 1:1 CG results in more favorable binding of SO₃SQ to the heme cleft of HSA, and slightly more improved binding in Sudlow's site II. Results of the Molecular Dynamics simulation for complexes of SO₃SQ-G-HSA with (FIG. 6A) glycolate in the heme cleft and SO₃SQ in Sudlow's site II and (FIG. 6B) glycolate in Sudlow's site II and SO₃SQ in the heme cleft.

FIGS. 7A-7D show adding CG 1:1 to HSA results in a size increase and a charge that is less negative. Adding CG 1:1 to a system containing 10 μM SO₃SQ and HSA causes the overall complex to increase in size and charge. Hydrodynamic diameter (intensity) of (FIG. 7A) HSA in water (black) and HSA in water with 160 mM CG 1:1 added (red). Zeta potential of (FIG. 7B) HSA in water (black), HSA in water with a 1:1 addition of 160 mM CG 1:1 added (red). Hydrodynamic diameter of (FIG. 7C) HSA in 10 μM SO₃SQ (black), HSA in 10 μM SO₃SQ with 1:1 added 160 mM CG 1:1 added (blue). Zeta potential of (FIG. 7D) HSA in 10 μM SO₃SQ (black), HSA in 10 μM SO₃SQ with a 1:1 addition of 160 mM CG 1:1 added (blue).

FIGS. 8A-8B show the interaction between SO₃SQ and HSA is exothermic in the absence of 1:1 CG, but is endothermic in the presence of CG 1:1. Representative isothermal titration calorimetry of HSA titrations into SO₃SQ. (FIG. 8A) A conventional reverse titration, showing the baseline-corrected injections (top) and integrated heats (bottom) in the absence of IL. The red line indicates the best fit finding profile, which has an exothermic heat. (FIG. 8B) The same experiment was performed in the presence of 40 mM IL. The enthalpy becomes positive, and the complete binding profile is not observed because of solubility limitations. The red line shows the average of the first 10 injections, which was used to estimate the enthalpy of binding.

FIGS. 9A-9D show the 1:1 SO3SQ/CG system does not destroy albumin's secondary structure or compromise the integrity of DNA. CD spectra of (FIG. 9A) human serum albumin (HSA) (black), HSA in 10 μM dye (red), and HSA in 10 μM dye with 160 mM CG 1:1. Overlaid CD spectra of (FIG. 9B) DNA only (blue) and DNA in 2.5% IL (red), (FIG. 9C) 9.14 μM dye in water (blue) and dye in 2.5% IL (orange), (FIG. 9D) DNA in 2.5% IL (black), DNA in 2.5% IL with 5 μL of 1 μM dye solution (red), DNA in 2.5% IL with 10 μL of 1 μM dye solution (yellow), and DNA in 2.5% IL with 15 μL of 1 μM dye solution (blue).

FIGS. 10A-10B show fluorescence scans of 10 μM dye in the (FIG. 10A) absence of blood and (FIG. 10B) presence of blood as the concentration of Choline Acetoxyacetate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 11A-11B show fluorescence scans of 10 μM dye in the (FIG. 11A) absence of blood and (FIG. 11B) presence of blood as the concentration of Choline Acetoxyacetate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 12A-12B show fluorescence scans of 10 μM dye in the (FIG. 12A) absence of blood and (FIG. 12B) presence of blood as the concentration of Choline 2-Methyl-2-Butenoate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 13A-13B show fluorescence scans of 10 μM dye in the (FIG. 13A) absence of blood and (FIG. 13B) presence of blood as the concentration of Choline 3-Octenoate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIG. 14A-14B show fluorescence scans of 10 μM dye in the (FIG. 14A) absence of blood and (FIG. 14B) presence of blood as the concentration of Choline Butyrate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 15A-15B show fluorescence scans of 10 μM dye in the (FIG. 15A) absence of blood and (FIG. 15B) presence of blood as the concentration of Choline Crotonate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 16A-16B show fluorescence scans of 10 μM dye in the (FIG. 16A) absence of blood and (FIG. 16B) presence of blood as the concentration of Choline Glycolate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 17A-17B show fluorescence scans of 10 μM dye in the (FIG. 17A) absence of blood and (FIG. 17B) presence of blood as the concentration of Choline Hexanoate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 18A-18B show fluorescence scans of 10 μM dye in the (FIG. 18A) absence of blood and (FIG. 18B) presence of blood as the concentration of Choline Hexanoate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 19A-19B show fluorescence scans of 10 μM dye in the (FIG. 19A) absence of blood and (FIG. 19B) presence of blood as the concentration of Choline Heptanoate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 20A-20B show fluorescence scans of 10 μM dye in the (FIG. 20A) absence of blood and (FIG. 20B) presence of blood as the concentration of Choline Isovalerate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 21A-21B show fluorescence scans of 10 μM dye in the (FIG. 21A) absence of blood and (FIG. 21B) presence of blood as the concentration of Choline Lactate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 22A-22B show fluorescence scans of 10 μM dye in the (FIG. 22A) absence of blood and (FIG. 22B) presence of blood as the concentration of Choline Levulinate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 23A-23B show fluorescence scans of 10 μM dye in the (FIG. 23A) absence of blood and (FIG. 23B) presence of blood as the concentration of Choline Octanoate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 24A-24B show fluorescence scans of 10 μM dye in the (FIG. 24A) absence of blood and (FIG. 24B) presence of blood as the concentration of Choline Pentanoate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIGS. 25A-25B show fluorescence scans of 10 μM dye in the (FIG. 25A) absence of blood and (FIG. 25B) presence of blood as the concentration of Choline Pentanoate 1:2 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIG. 26 shows fluorescence spectra of 10 μM dye after the addition of Choline Glycolate 1:1 in the presence of blood (red). Fluorescence spectra of 10 μM dye after the addition of Imidazolium Glycolate 1:1 in the presence of blood (green).

FIG. 27 shows fluorescence spectra of 10 μM dye with 160 mM glycolic acid (purple), 10 μM dye with 160 mM of both choline bicarbonate and glycolic acid added together not in IL form (green), 10 μM dye (blue), and 10 μM dye after the addition of 160 mM of the IL CG 1:1 (red), all after the addition of blood.

FIG. 28 shows fluorescence scans of HSA in water as the concentration of Choline Glycolate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIG. 29 shows a fluorescence scan of HSA in 10 μM dye as the concentration of Choline Glycolate 1:1 is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIG. 30 shows a fluorescence scan of HSA in 10 μM dye as Choline Glycolate 1:1 is added to the HSA solution prior to the addition of the dye, and the IL concentration is varied from 0 mM (green solid line), 40 mM (gray dashed line), 80 mM (blue solid line), 120 mM (purple solid line), 160 mM (red solid line), 200 mM (navy dashed line), and 240 mM (black solid line) of IL in water.

FIG. 31A shows fluorescence of Tyrosine (black) and Tryptophan (red) when excited at 275 nm. FIG. 31B shows fluorescence of Tyrosine (black) and Tryptophan (red) when excited at 295 nm.

FIGS. 32A-32B show DLS data of SO₃SQ in water showing (FIG. 32A) complex size, and (FIG. 32B) complex charge.

FIGS. 33A-33B show DLS data of choline glycolate 1:1 in water showing (FIG. 33A) complex size, and (FIG. 33B) complex charge.

FIGS. 34A-34B show DLS data of choline glycolate 1:1 in SO₃SQ showing (FIG. 34A) complex size, and (FIG. 34B) complex charge.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

In one aspect, disclosed herein is a composition including an ionic liquid-solvated indolizine squaraine dye for the detection of latent blood. In a further aspect, when the disclosed system comes into contact with blood, the dye component binds with serum albumin. In a still further aspect, fluorescence of the dye in the near-infrared range increases by several orders of magnitude.

### Compositions for Determining Whether a Substance is Blood

In one aspect, disclosed herein is a composition for determining whether a substance is blood, the composition including at least an ionic liquid and a near infrared (NIR) dye in an aqueous solution. In some aspects, the NIR dye can be or include an indolizine-donor based squaraine dye as described further herein such as, for example, SO₃SQ, although other dyes having the same general scaffold can also be used in the compositions and methods disclosed herein.

In one aspect, the ionic liquid includes a choline cation; however, for certain applications, other bulky cations may also be used. In another aspect, the ionic liquid includes an anion selected from acetoxyacetate, glycolate, hexanoate, octanoate, pentanoate, 3-octenoate, heptanoate, 2-methyl-2-butenoate, 3-methyl butanoate, lactate, butanoate, levulinate, 2-butenoate, or any combination thereof.

In any of these aspects, the ionic liquid has a cation to anion ratio of from about 1:1 to about 1:2, or of about 1:1, 1.1:1, 1.2:1, 1.3:1, 1.4:1, 1.5:1, 1.6:1, 1.7:1, 1.8:1, 1.9:1, or about 2:1.

In some aspects, the ionic liquid can be choline glycolate having a ratio of choline to glycolate of 1:1.

In another aspect, the ionic liquid can be present in the composition in a concentration of from about 40 mM to about 240 mM, or from about 40 mM to about 200 mM, about 40 mM to about 160 mM, about 80 mM to about 160 mM, about 80 mM to about 240 mM, or about 40, 80, 120, 160, 200, or about 240 mM, or a combination of any of the foregoing values, or a range encompassing any of the foregoing values. In another aspect, the NIR dye is present in a concentration of about 10 μM.

In any of these aspects, the composition is stable during storage for at least 2 months at a temperature of from about 4° C. to about 25° C., or from about 20° C. to about 25° C., or from about 8° C. to about 20° C., or at about 4, 5, 6, 7, 8, 9, 10, 11, 23, 13, 14, 15, 16, 17, 18, 19, 20, 21, 22, 23, 24, or about 25° C., or a combination of any of the foregoing values, or a range encompassing any of the foregoing values.

In one aspect, the disclosed composition expresses an increase in fluorescence quantum yield (Φ_{f}) of at least 4× in the presence of human serum albumin. In another aspect, the composition preferentially binds to HSA over other mammalian serum albumin proteins.

### Method for Determining Whether a Substance is Blood

In one aspect, disclosed herein is a method for determining whether a substance is blood, the method including at least the step of contacting the substance or contacting a surface where a bloodstain is believed to be present with a disclosed composition and visualizing the substance or surface.

In some aspects, the substance can be in aqueous solution and the substance can be visualized by fluorescence spectroscopy. Further in this aspect, an excitation wavelength of about 690 nm can be used to visualize the substance when the dye is SO₃SQ, and emission can be observed between about 700 nm and about 772 nm. In one aspect, performing the method does not degrade or damage any DNA present in the substance.

### Method for Increasing Fluorescence Quantum Yield of a Dye

In one aspect, disclosed herein is a method for increasing the fluorescence quantum yield of an indolizine-donor based squaraine dye, the method including at least the step of contacting an aqueous composition including the dye and an ionic liquid with human serum albumin. In some aspects, the dye is SO₃SQ.

In one aspect, the ionic liquid includes a choline cation; however, for certain applications, other bulky cations may also be used. In another aspect, the ionic liquid includes an anion selected from acetoxyacetate, glycolate, hexanoate, octanoate, pentanoate, 3-octenoate, heptanoate, 2-methyl-2-butenoate, 3-methyl butanoate, lactate, butanoate, levulinate, 2-butenoate, or any combination thereof.

In any of these aspects, the ionic liquid has a cation to anion ratio of from about 1:1 to about 1:2, or of about 1:1, 1.1:1, 1.2:1, 1.3:1, 1.4:1, 1.5:1, 1.6:1, 1.7:1, 1.8:1, 1.9:1, or about 2:1. In some aspects, the ionic liquid can be choline glycolate having a ratio of choline to glycolate of 1:1.

In any of these aspects, the dye can experience an increase in fluorescence quantum yield (Φ_{f}) of at least 4×. In one aspect, an excitation wavelength of about 690 nm can be used to visualize the dye, and emission can be observed at from about 700 to about 772 nm.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an anion,” “a tryptophan residue,” or “an ionic liquid,” include, but are not limited to, mixtures, combinations, or series of two or more such anions, tryptophan residues, or ionic liquids, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of an anion refers to an amount that is sufficient to achieve the desired improvement in the property modulated by the formulation component, e.g. achieving the formation of an ionic liquid with a choline cation. The specific level in terms of wt % in a composition required as an effective amount will depend upon a variety of factors including the amount and type of dye added to the ionic liquid, synthesis conditions, and end use of the ionic liquid.

As used herein, the terms “optional” or “optionally” means that the subsequently described event or circumstance can or cannot occur, and that the description includes instances where said event or circumstance occurs and instances where it does not.

“Human serum albumin” (HSA) is the most abundant protein in human blood plasma. HSA is a globular, monomeric protein that transports hormones, fatty acids, drugs, and other molecules in the body. “Sudlow site I” and “Sudlow site II” are binding sites found on HSA, with Sudlow site I binding primarily to bulky heterocyclic compounds and Sudlow site II binding to smaller aromatic compounds.

Unless otherwise specified, pressures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Materials

Choline bicarbonate (80% in water) and the respective anions used in the IL synthesis are commercially available and purchased from Sigma-Aldrich (Milwaukee, WI) and TCl America (Portland, OR). Lyophilized HSA (96% pure) was purchased from Sigma-Aldrich (Milwaukee, WI). SO₃SQ dye was synthesized as previously described. Human whole blood was purchased from Bio-IVT (Gender pooled, stored cold, and delivered next-day, Westbury, NY) and used as approved by the Institutional Biosafety Committee at the University of Mississippi. A Milli-Q IQ 7000 water purification was used to produce the water (resistivity of 18.2 Mn-cm at 25° C.) used for sample preparation. Polished quartz cuvettes with a path length of 1 cm were purchased from Hellma Analytics for fluorescence spectroscopy. For light scattering experiments to measure the size of the system, DTS0012 cuvettes were purchased from Sarstedt (Newton, NC) and folded capillary cells for measuring zeta potential were obtained from Malvern Panalytical (Malvern, U.K.).

### Synthesis and Characterization of ILs

The ILs are synthesized according to previously published reaction procedures. A general procedure for preparing ILs is shown in Scheme 2.

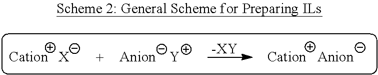

Choline containing ILs are prepared in 1:1 or 1:2 choline/anion ratios via a salt metathesis reaction (Scheme 3). Briefly, the anion is placed in a round-bottomed flask on a hot plate at 50° C. The choline bicarbonate is then added dropwise. After the addition is complete, the solution is left stirring at 270-300 rpm at a temperature of 50° C. for 24 h. After 24 h, the solution is placed on a rotary evaporator for 1 h at 15 mbar to remove excess water. The IL is then placed in a vacuum oven set to 60° C. and −760 mmHg relative to ambient pressure for 48 h. The water content of the IL is then measured by using a Karl Fischer coulometer (Metrohm). Because water content can be corrected for before addition to aqueous solution, achieving ultradry ILs was not necessary. With that said, ILs were dried until they contained less than 10% water w/w. Choline glycolate (1:1) was measured as 1.17% water w/w. The ILs are then characterized via ¹H NMR spectroscopy.

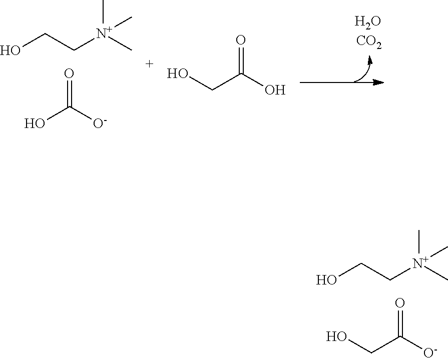

Dropwise addition of a 1:1 molar ratio of choline bicarbonate to glycolic acid to synthesize the IL choline glycolate (CG (1:1)) via a salt metathesis reaction

### Conductivity Measurements

Conductivity was measured using a Thermo Scientific Orion Star A212 conductivity meter using a DuraProbe 4-electrode conductivity cell. The 160 mM solutions of CG 1:1 were prepared in either water or SO₃SQ. For the purpose of comparing conductivities, solutions of 160 mM of choline bicarbonate and glycolic acid, as well as NaCl, were also prepared in water and dye. The clean probe was introduced into each solution to record the conductivity. The conductivity was measured in triplicate for each of the solutions.

### Fluorescence Measurements of Dye/IL Systems

A 10 μM SO₃SQ stock solution was prepared in Milli-Q water, and the volume of this solution for each fluorescence measurement was held constant at 3 mL. To record the initial fluorescence intensity of the system without ILs, 0.5 μL of human whole blood was added to the 3 mL of dye solution. To test the impact the ILs had on the dye's fluorescence (both with and without blood), each IL was added in 40 mM increments until a final IL concentration of 240 mM was reached. This resulted in seven different IL concentrations to be tested: 40, 80, 120, 160, 200, and 240 mM. The fluorescence measurements were recorded with an excitation wavelength of 690 nm and emission was monitored from 700-772 nm. The slit widths for excitation were set to 8 nm, and the emission slit widths were set to 15 nm. The steadystate emission data was collected using a Horiba PTI QuantaMaster QM-8075-21 fluorometer (Horiba, Kyoto, Japan) equipped with a silicon-based PhotoMultiplier Tube (PMT) in the visible region (700-772 nm) with a step size of 4 nm and excitation and emission slit widths at 3 and 1.5 nm, respectively, with 690 nm used as the excitation wavelength from a 75 W xenon lamp. For both the neat and IL-addition dyes, Milli-Q water was used as the solvent. Emission blanks of the relevant solvents were subtracted from subsequent dye and IL-addition dye emission. Sample and reference concentration was kept below 1 Abs unit to minimize inner filter effects. Rectangular 10 mm path cuvettes were used for all fluorescence measurements under an ambient atmosphere.

### Fluorescence Measurements of Albumin Tryptophan Residue

Samples were prepared by using a freshly made 10 μM stock solution of SO₃SQ in water. The sample volume for analysis was 3 mL. Lyophilized HSA was added into these samples at 0.1 mg/mL. Control samples were run in Milli-Q water. Twenty-five μL of CG 1:1 was added after each subsequent scan to increase the solution's CG 1:1 concentration by 40 mM upon each addition. The impact of the IL's concentration on the tryptophan residue's fluorescence was done in water both with and without SO₃SQ present. In these samples, the required volume of IL was added to a solution of water and albumin (0.2 mg/mL). Twenty μM SO₃SQ stock solution was added 1:1 with the HSA/water/IL solution to achieve a final dye concentration of 10 μM and to maintain a concentration of 0.1 mg/mL HSA. The fluorescence measurements for all three scans were recorded with an excitation wavelength of 275 nm, and the emission was monitored over the range of 285-415 nm, as described above. Although tryptophan is the dominant emitting species in HSA, it is important to note that fluorescence due to the more abundant tyrosine residues is also present if exciting at a wavelength of 275 nm. To combat this, previous literature states that tryptophan residues can be targeted specifically without exciting tyrosine residues if the excitation wavelength is around 290-295 nm. These additional measurements were carried out at an excitation wavelength of 295 nm, with emission being monitored over the range of 305-415 nm.

### Dynamic Light Scattering (DLS)

DLS size and zeta potential measurements of the systems containing HSA were performed on a Malvern Panalytical Zetasizer Advance Series instrument. All measurements were performed at a constant temperature of 25° C. with water as the dispersant (refractive index, 1.33; viscosity, 0.887 cP; dielectric constant, 78.5). Hydration particle size was measured as intensity. SO₃SQ (10 μM in water) was set as the primary material for each scan, and its refractive index and absorptivity are 0.9 and 1.2, respectively. Samples of HSA were prepared at 0.1 mg/mL of either water or 10 μM SO₃SQ. The IL CG 1:1 was added at 160 mM, the concentration that yielded the maximum fluorescence intensity. The system of HSA in water with and without IL was measured along with the system of HSA in 10 μM SO₃SQ with and without IL. Each sample was prepared fresh three times to allow the size and zeta potential to be measured in triplicate.

### Isothermal Titration Calorimetry (ITC)

ITC measurements were carried out in triplicate on a Malvern VP-ITC. Uncertainties are provided as the standard error of the mean. The solvent was either buffer alone (25 mM sodium phosphate, pH 6.5) or buffer plus 40 mM CG 1:1. HSA was dialyzed into the appropriate buffer, and solid SO₃SQ was dissolved in dialysis buffer to ensure a close buffer match. This was necessary in order to prevent strong heats of dilution that are often observed when ILs are titrated in separately. Both HSA and dye solutions were degassed for 10 min before experiments. A typical experiment contained 60 μM HSA in the syringe and 60 μM dye in the calorimetry cell. A total of 28 injections were typically used, each 10 μL in volume, and 10 min of equilibration time was allowed to occur between injections. Measurements were performed at 25° C. Because injection heats and corresponding signal-to-noise ratios were small, manual baseline fitting was performed using Origin software. Since K and N cannot be determined using this ratio of HSA and dye in the presence of CG 1:1, only the enthalpy is accessible from these measurements. The enthalpy for each ITC experiment was reported as the average enthalpy of the first 10 useable injections, which were all similar. The first injection often exhibited a systematically lower heat than the other injections because of sample diffusion during the experimental setup, and it was not typically used. For reverse titrations, performed without CG 1:1, N, K, and ΔH were fit using CHASM, and the heat of the final injection was used as the baseline. The number of binding sites per HSA molecule was reported as the inverse value of N from fitting, as is typical for reverse titrations. Finally, titrations were also performed where SO₃SQ or HSA was systematically removed, one at a time, in the presence and absence of CG 1:1, to determine whether dilution heats were contributing to the measured enthalpy. In all cases, dilution heats were small, less than 10% of the observed enthalpy, and no further corrections were made.

### Circular Dichroism (CD) Spectroscopy

CD experiments to determine the impact the 1:1 SO₃SQ and CG 1:1 may have on HSA and DNA were performed on a Jasco J-1500 CD spectrophotometer. The measurements were performed using a Jasco Spectrosil 1 mm path length cuvette. Samples containing HSA were prepared at 1 mg/mL in either water, 10 μM SO₃SQ in water, and 10 μM SO₃SQ in water with 1:1 160 mM CG 1:1 added. The protein scans were conducted at a 200-260 nm range. For measurements involving DNA, bacterial plasmid DNA was used, and the DNA concentration was maintained at 12 nM across all samples due to high instrument sensitivity. CG 1:1 was added at 2.5% v/v to achieve a 160 mM concentration. A solution of 9.14 μM SO₃SQ in water was made and added to DNA solutions in 5 μL increments. These scans were completed over a 200-350 nm range.

### Computational Details

All calculations were performed using the Schrodinger Software Package. The structure of HSA was retrieved from the Protein Data Bank (PDB 1 N5U) and prepared by using a Protein Preparation Wizard module. Hydrogen atoms were added, and bond orders were assigned based on their simplified molecular-input, line-entry system (SMILES) strings in the Chemical Component Dictionary (CCD). Missing loops and side chains were filled in using Prime, and the protonation states were generated using Epik with a pH value of 7.0±2.0. The OPLS3e force field was used to optimize the hydrogen bond network and perform restrained minimization. The optimized dye structure was retrieved from previous work. The 3D structures of choline and glycolate were visualized and subjected to LigPrep. The prediction of the binding pose was achieved with molecular docking and was carried out using the Glide module. Grids were generated being centered on a cocrystallized ligand for the Heme Cleft (x: 28.459; y: 9.064; z: 33.498), important residues of the Sudlow's site I (x: 28.424; y: 3.344; z: 8.941), and the Sudlow's site II (x: 3.822; y: 2.044; z: 22.401) with the length of 40 Å. An extra precision (XP) method and OPLS3e force fields were used for flexible ligand docking. Obtained complexes were further used to refine interactions and estimate binding affinities with the MM-GBSA calculations implemented in Prime. The VSGB solvation model and OPLS3e force field were used. Protein residues at a distance of 12.0 Å from the ligand were set to be flexible. Once the complexes were refined, they were subjected to MD simulations implemented in the Desmond module. Models were built inside the 20.0 Å orthorhombic cell, filled with water molecules (SPC solvent model), and neutralized with Na⁺ ions. The temperature and pressure were maintained at 300 K and 1.01325 bar, respectively. The simulation time was set to 50 and 100 ns with a time step of 25 ps. Further, an analysis of trajectories was carried out using the Simulation Interaction Diagram and Trajectory Clustering.

### Example 2: Results and Discussion

### Synthesis and Characterization of ILs

To test which IL anion generated the largest improvement in the dye's fluorescence in the presence of blood, a large library of choline carboxylate ILs was synthesized using varying anions and characterized as described in the section above. The ILs were synthesized via a salt metathesis reaction (Scheme 1) in which choline bicarbonate and the desired carboxylic acid were combined in 1:1 or 1:2 molar ratios. Several structural features within the ILs were investigated, namely, (1) ratio of choline to anion, (2) chain length, (3) the presence or absence of double bonds, and (4) the presence of terminal hydroxyl groups. The structures of the anions used can be found in Example 3.

### Conductivity Measurements

For the purpose of further comparing the CG 1:1 systems with those containing the IL precursors, conductivity measurements were taken. Previous research has investigated the conductivity of a variety of ILs in aqueous solutions. Tsuzuki et al. demonstrate that ILs, despite being ions in solution, show lower conductivity in aqueous solutions due to ion pair formation within the IL. In systems in which ILs are present in aqueous solutions, the conductivity is shown to increase as the solution becomes more and more dilute. This increase in conductivity is attributed to the dissociation of ion pairing caused by the water molecules disrupting the hydrogen bonding between the anion and cation. In the present study of CG 1:1 in aqueous solutions, an average conductivity of 189.4±0.7 μS/cm was measured for the 160 mM CG 1:1 solution in water and an average conductivity of 187.0±0.5 μS/cm for the solution of 160 mM CG 1:1 in SO₃SQ (Table 1 shows all of the conductivity data). At that concentration of IL, this is still a much lower conductivity than that of traditional salts. The solutions of NaCl prepared at a concentration of 160 mM showed an average conductance of 20.4±0.2 mS/cm, 100× higher than that of the IL. Additionally, the IL precursors, choline bicarbonate and glycolic acid, were added into solution, and their conductivity was recorded. For this solution in water, the average conductivity was only 7.0±0.3 μS/cm, while that in SO₃SQ was 13.1±0.1 μS/cm. This data suggest that the IL components are still associated in the aqueous solution as they interact with the SO₃SQ and the albumin.

TABLE 1
Results of Conductivity Measurements (μS/cm)

| | Replicate 1 | Replicate 2 | Replicate 3 | Mean ± SD |
|---|---|---|---|---|
| water + CG 1:1 | 190 | 189.5 | 188.6 | 189.4 ± 0.7 |
| SO₃SQ + CG 1:1 | 186.8 | 186.6 | 187.5 | 187.0 ± 0.5 |
| water + choline bicarbonate + | 7.3 | 7.0 | 6.8 | 7.0 ± 0.3 |
| glycolic acid | | | | |
| SO₃SQ + choline bicarbonate + | 13.03 | 13.17 | 13.12 | 13.1 ± 0.1 |
| glycolic acid | | | | |
| NaCl | 20.2 | 20.6 | 20.3 | 20.4 ± 0.2 |

### Fluorescence Measurements

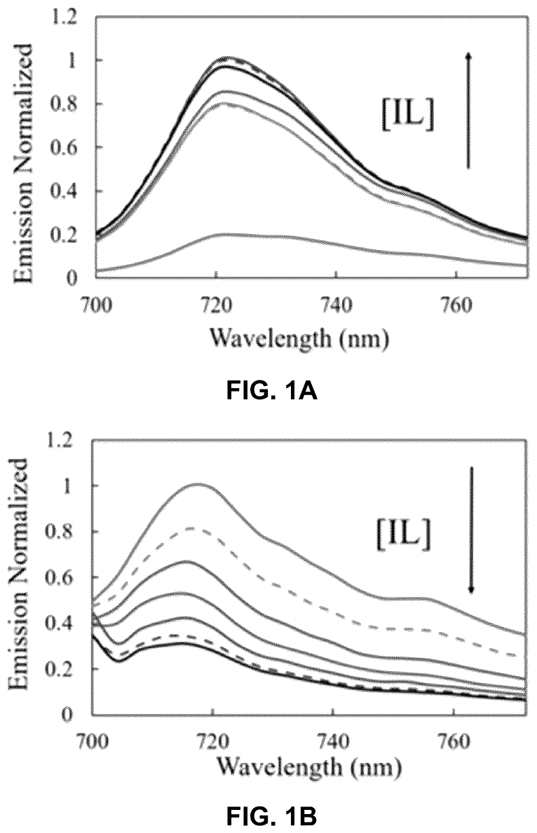

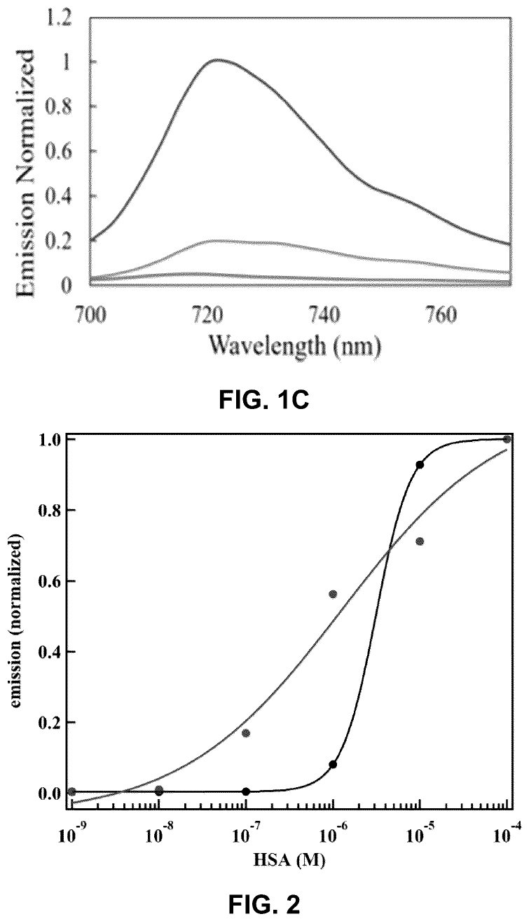

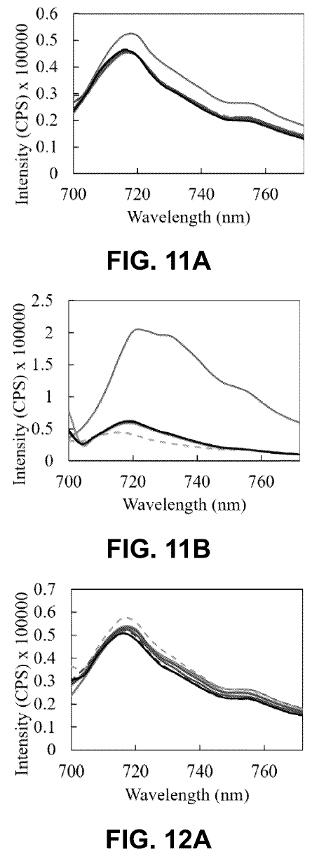

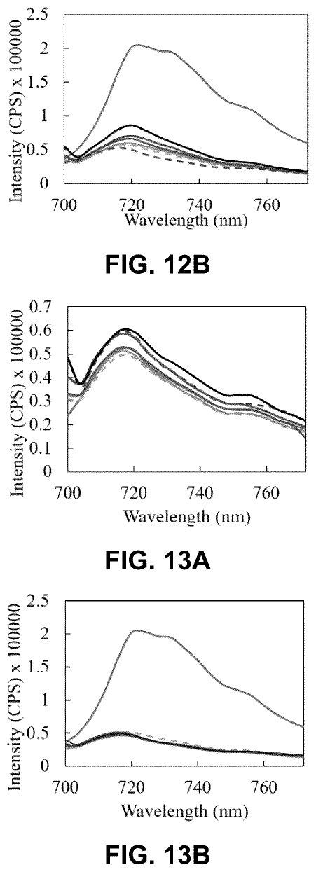

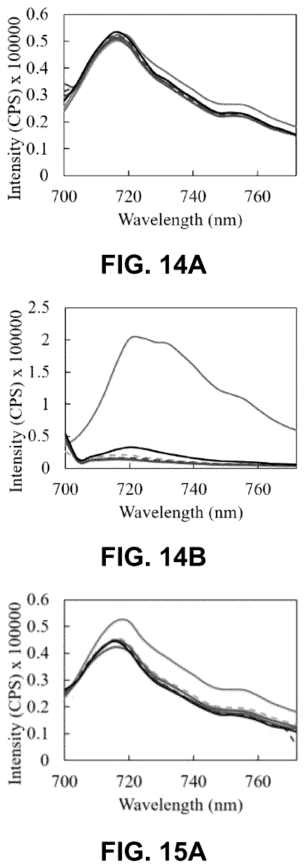

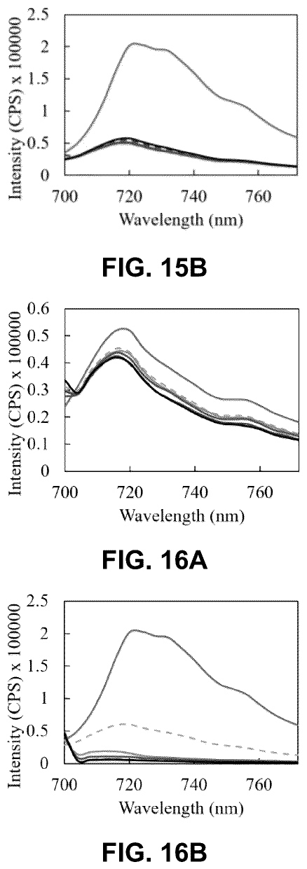

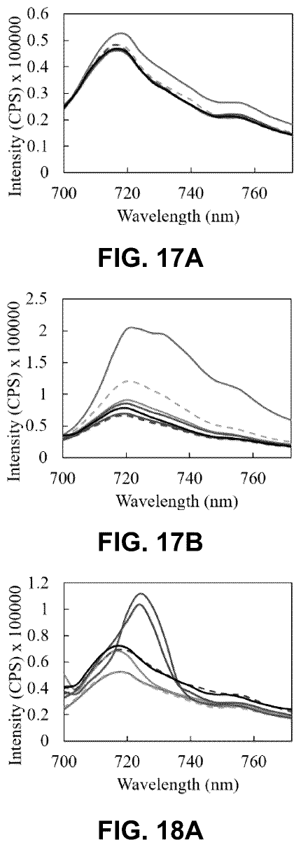

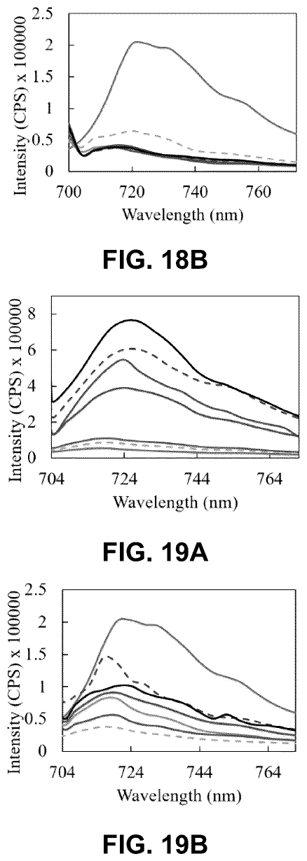

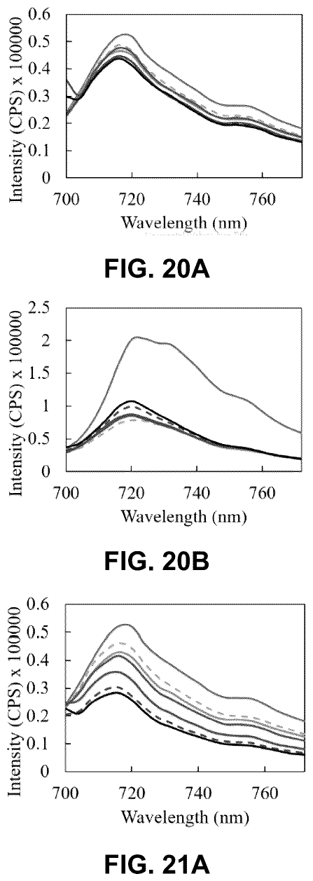

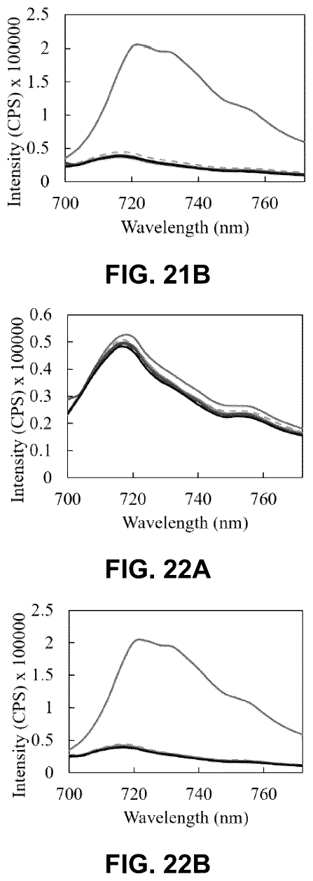

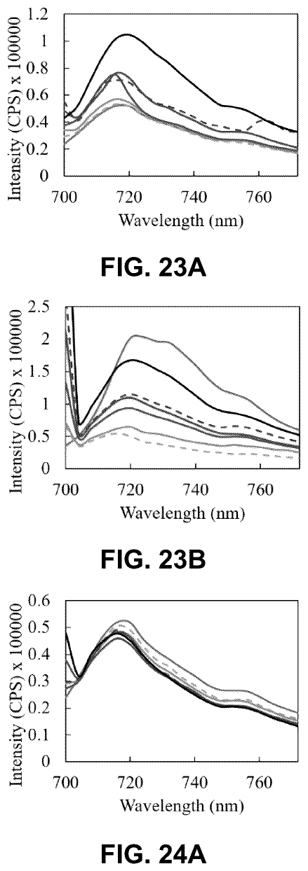

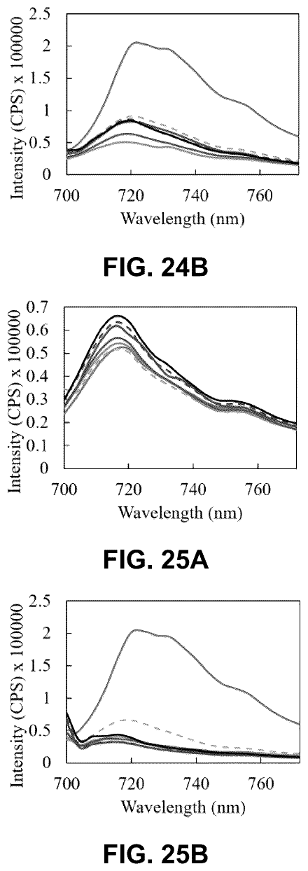

To assess the ability of each IL to enhance the fluorescence of SO₃SQ dye in human whole blood, the fluorescence emission of 3 mL of a 10 μM dye solution was taken and the fluorescence was measured again after the addition of 0.5 μL of human whole blood. The fluorescence intensity of the dye alone in water shows a 4× increase after the addition of blood (FIG. 1C). The addition of blood also results in a redshift of the wavelength of maximum intensity from 716 to 724 nm. From here, fluorescence concentration scans of each IL were performed. Each IL was scanned from a concentration of 0 to 240 mM and increments of 40 mM were used. The spectra of the concentration scans for each IL can be found in FIGS. 10A-25B. The data obtained from the IL concentration scans confirmed that both the concentrations used and the structural features of each IL anion had an effect on the dye's fluorescence. While some ILs resulted in slight increases in the dye's fluorescence in the presence of blood with increasing concentration, others showed a systematic decrease in the dye's fluorescence in the presence of blood with increasing concentration. ILs of a 1:2 cation to anion ratio resulted in higher fluorescence intensity of the dye in the absence of blood when compared to those of a 1:1 ratio. ILs containing double bonds nearly maintain the dye's maximum fluorescence intensity in the absence of blood, while sharply decreasing it in the presence of blood's presence. Most ILs other than CG 1:1 do not result in a noticeable decrease in the dye's fluorescence intensity in the absence of blood with increasing IL concentration, perhaps due to the lack of the terminal hydroxyl group that CG 1:1 contains. For dye/IL systems in the presence of blood, no general trends in fluorescence intensity were observed based on alkyl chain length. Since these IL/dye systems are being investigated as a potential alternative bloodstain detection method, there must not be discernible fluorescence in the absence of blood, as this could lead to undesired false positives. The optimal candidate is therefore an IL that shows both the greatest fluorescence increase in the presence of blood and a suppression of the dye's fluorescence in the absence of blood.

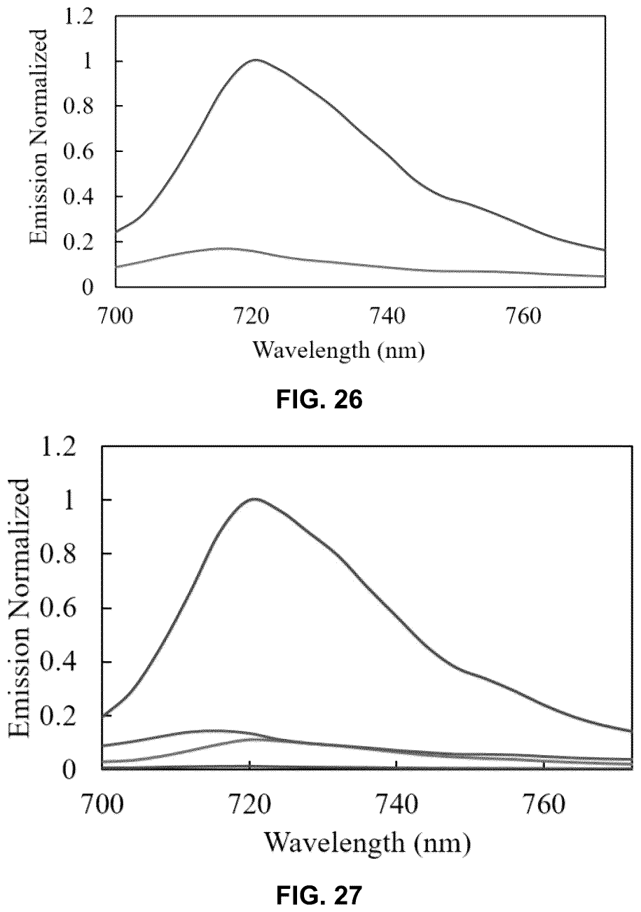

The IL, choline glycolate (1:1) (CG (1:1)), whose fluorescence spectra are shown in FIGS. 1A-1C was selected as the optimal candidate. The increasing concentration of CG (1:1) showed a noticeable increase in the fluorescence of the dye in the presence of blood (FIG. 1A), and a decrease in the fluorescence of the dye in the absence of blood (FIG. 1B). To visualize the fold-changes more easily across each system, each figure is normalized relative to the maximum emission intensity of that particular data set. The optimal concentration of CG (1:1) was found to be 160 mM, increasing the dye's fluorescence by a factor of 5 (FIG. 1C) in the presence of blood relative to the sample without any IL. To confirm that both the anion and the cation played a crucial role in allowing this fluorescence increase, spectra of 10 μM dye with 160 mM of the IL imidazolium glycolate were also recorded (FIG. 26) and showed no appreciable fluorescence enhancement. Additionally, FIG. 27 demonstrates that the formation of the IL prior to its addition into the 10 μM aqueous dye solution is of utmost importance, as the glycolic acid or the addition of both choline bicarbonate and glycolic acid together have little impact on the dye's fluorescence after the addition of blood, consistent with the conductivity measurements reported above.

### Normalized Fluorescence and System Binding

With significant increases in the dye's fluorescence being observed due to the presence of 160 mM CG (1:1), the interaction between the dye and IL moieties in the presence of human serum albumin was next explored. Fluorescence intensity of both the 10 μM dye system and the 10 μM dye/160 mM IL system was monitored over a range of albumin concentrations, and a plot was constructed from fitting the data of these normalized fluorescence intensities with the Hill eq (FIG. 2). The system containing SO₃SQ and CG is seen to undergo an increase in fluorescence at albumin concentrations lower than those of the system with SO₃SQ alone. An apparent dissociation constant (K_{D,app}) and association constant (K_{A}=K_{D,app}⁻¹) can be gained from this plot, assuming that all binding sites on HSA are identical and independent, and assuming that binding is saturated. These assumptions may not hold for HSA in the absence of IL, as multiple transitions might be present (FIG. 2, black). The K_{A,app} value of HSA in SO₃SQ is estimated to be 3.2×10⁵, while the K_{A} value of HSA in SO₃SQ in the presence of IL is estimated at 9.1×10⁵, demonstrating that the IL facilitates greater binding affinity. From the K_{A} values, the free energy of binding was calculated using this equation: ΔG₀ₐₚₚ=−RT In K_{A,app}, where R is the gas constant. For the system containing just the dye, the free energy of binding was estimated as −7.4 kcal mol⁻¹, and for the system containing the dye and IL, the free energy of binding was estimated to be −8.0 kcal mol⁻¹. This is consistent with the value previously reported at a concentration of 1 μM. These values show that CG (1:1) allows the dye to bind more favorably to HSA than if the dye is binding HSA by itself.

### HSA Tryptophan Fluorescence

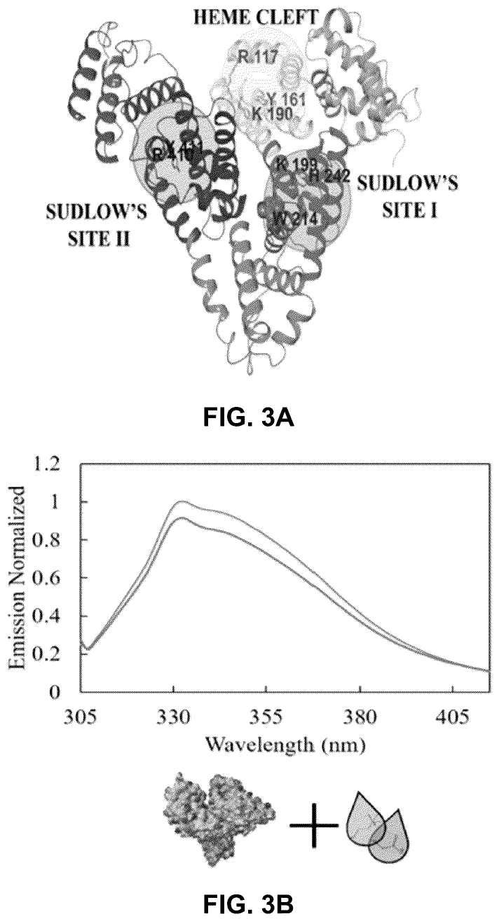

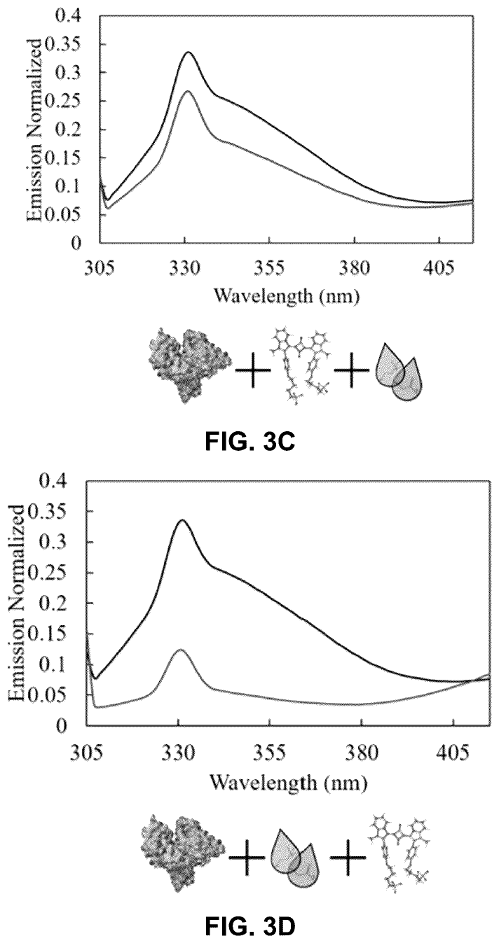

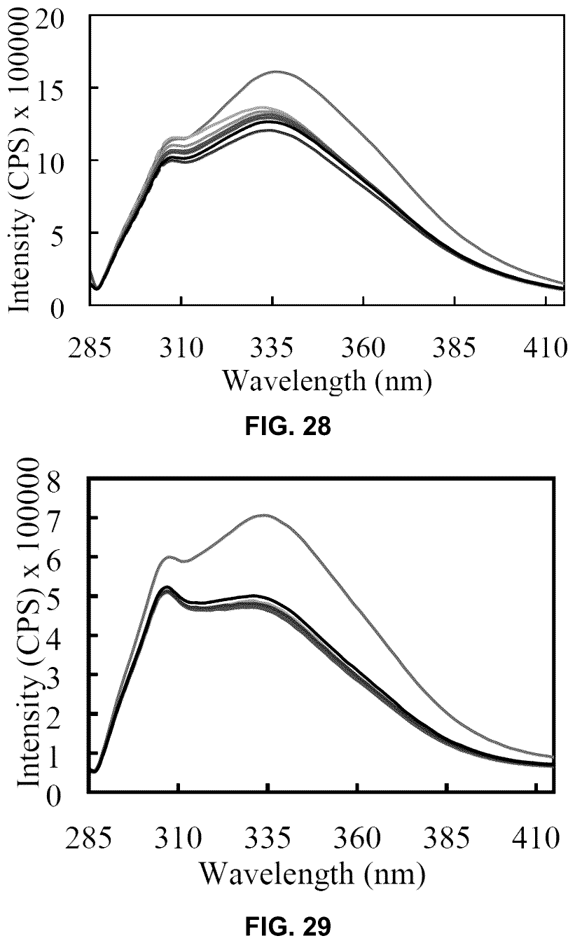

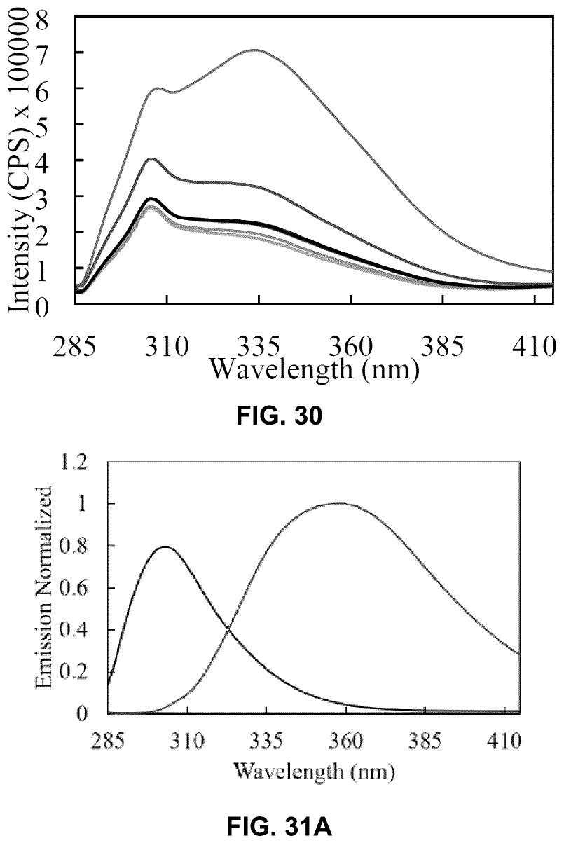

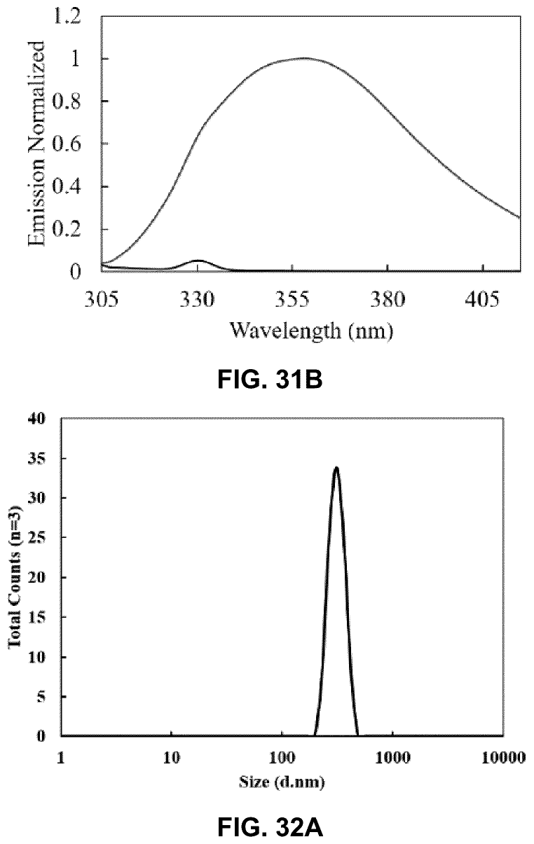

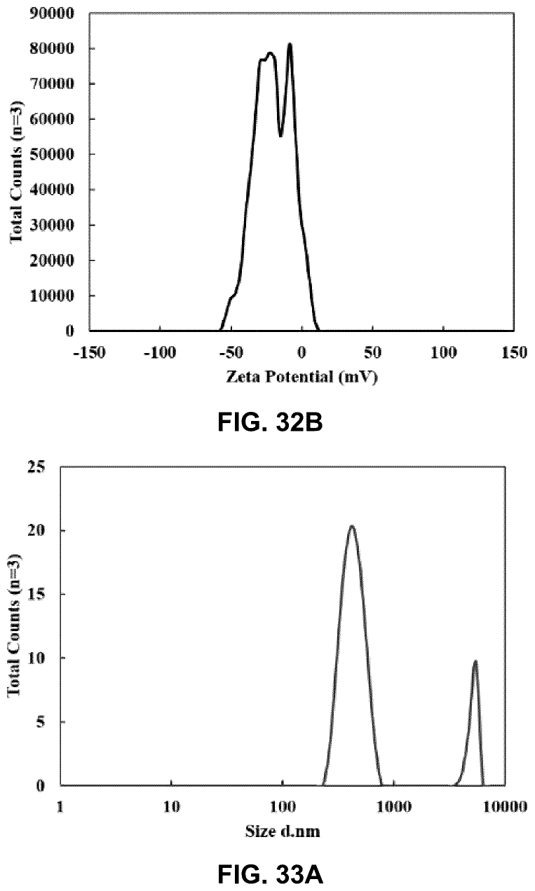

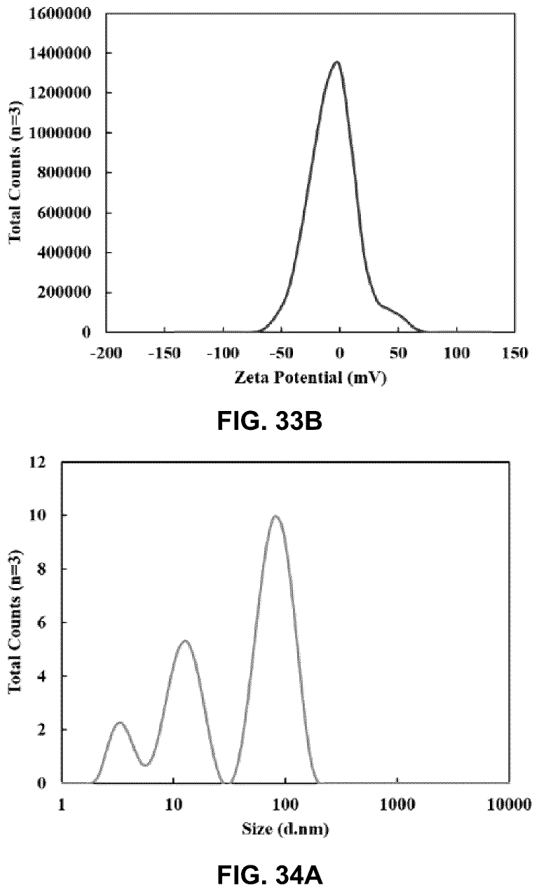

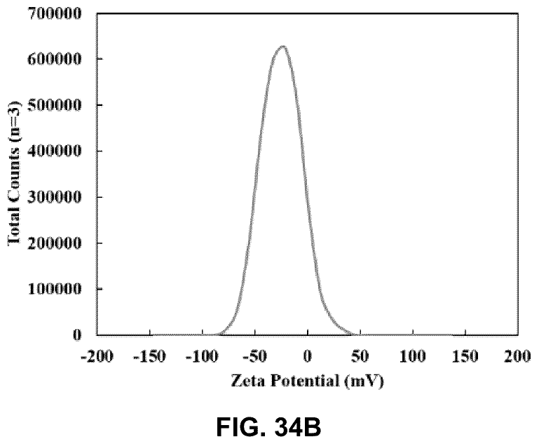

Fluorescence of the tryptophan residue of HSA was measured as a function of increasing IL concentration to provide information about the location of the interaction among SO₃SQ/HSA, CG (1:1)/HSA, and SO₃SQ/CG (1:1). This residue was selected to monitor because the tryptophan residue resides in Sudlow's Site I of HSA, which may be implicated in binding between HSA and the dye.4 The same IL concentration range was employed here as in the studies monitoring the fluorescence of the dye. To understand whether the order in which the IL or dye is added into the HSA solution has an impact on tryptophan fluorescence, the IL concentration scan was performed under 3 conditions: (1) CG (1:1) added into a solution of 0.1 mg/mL HSA in water (no dye); (2) CG (1:1) added into a solution of 0.1 mg/mL HSA in 10 μM SO₃SQ (dye already present); (3) SO₃SQ added into solutions of 0.1 mg/mL HSA in water with the varying concentrations of CG (1:1; IL already present). FIGS. 3A-3D show the resulting tryptophan fluorescence spectra for HSA solutions in the presence of 10 μM SO₃SQ or 160 mM CG (1:1). The spectra of the entire concentration scan for each scenario are shown in FIGS. 28-30. Preliminary spectra of tyrosine and tryptophan with excitations at 275 and 295 nm can be found in FIGS. 31A-31B. Adding increasing amounts of CG (1:1) into a solution of HSA in water resulted in a decrease in the intensity of the fluorescence of the tryptophan residue of about 10% (FIG. 3B). A 4 nm blueshift from a wavelength maximum of 333 nm to a wavelength maximum of 329 nm was also observed after the addition of CG (1:1). A greater decrease in the intensity of the fluorescence of the tryptophan residues (˜70%) was observed in the scenario in which increasing amounts of CG (1:1) were added to a solution of HSA that already contained 10 μM SO₃SQ (FIG. 3C, condition 2). For the third scenario, where CG (1:1) was present in the aqueous HSA solution prior to the addition of SO₃SQ, the greatest reduction of the fluorescence is seen (˜90%, FIG. 3D, condition 3). Notably, the change in the concentration of IL after the initial addition did not seem to have an appreciable impact on the tryptophan fluorescence (as distinct from the dye fluorescence reported above, where the optimal concentration was 160 mM). The degree of fluorescent emission correlates with the degree of interaction with the tryptophan residue, with greater decreases indicating a greater interaction. Therefore, it can be inferred that the IL alone has some interaction with the tryptophan residue in HSA, and this interaction is enhanced greatly in the presence of the dye. The computational details provide the potential mechanism of such an interaction. Interestingly, even greater reductions in the fluorescent emission are observed when the IL is in solution with the HSA as the dye is added, suggesting that the IL may “prime” greater interactions between the albumin and the dye. This will be explored further below.

### Computational Modeling

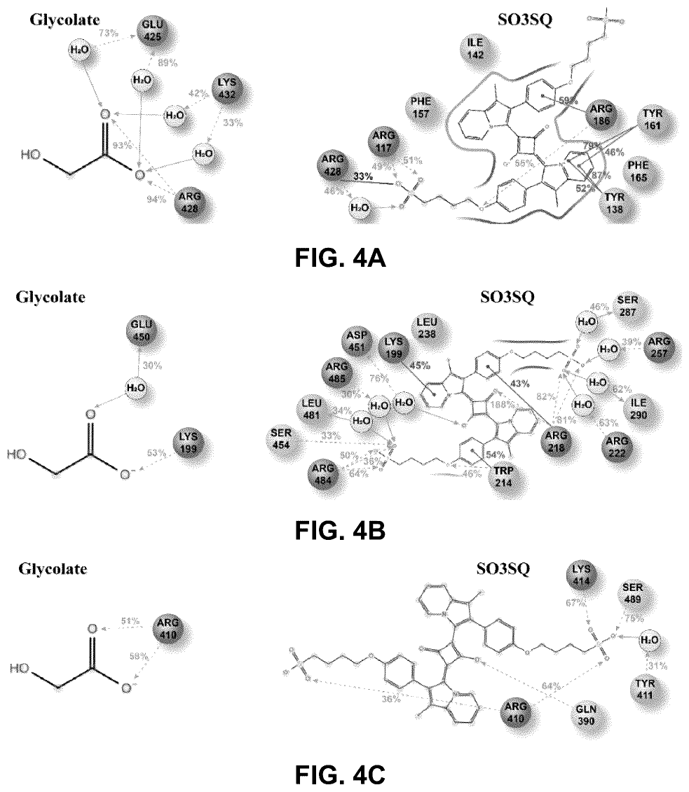

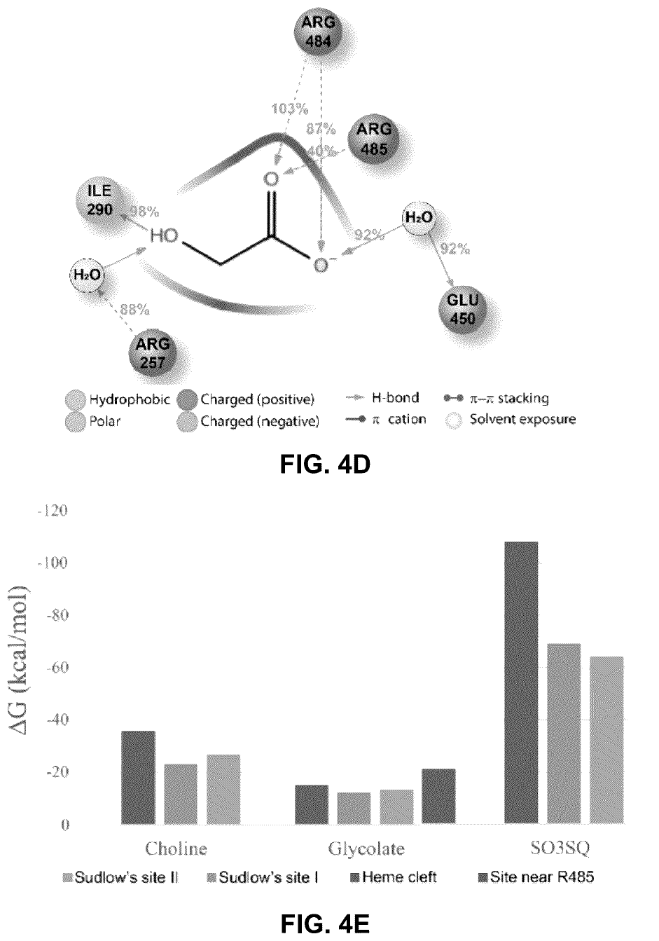

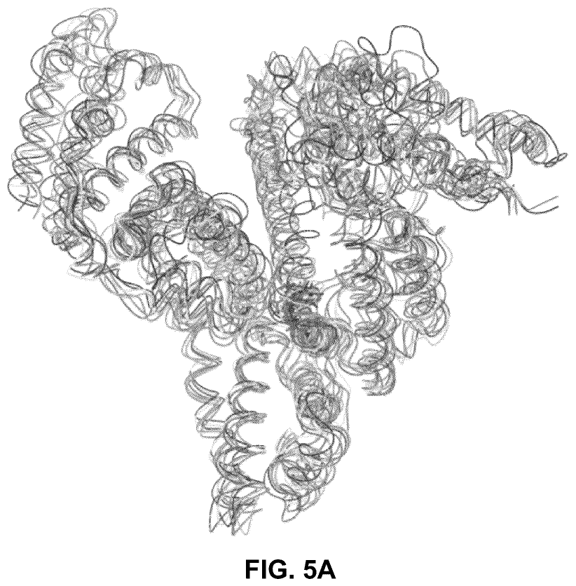

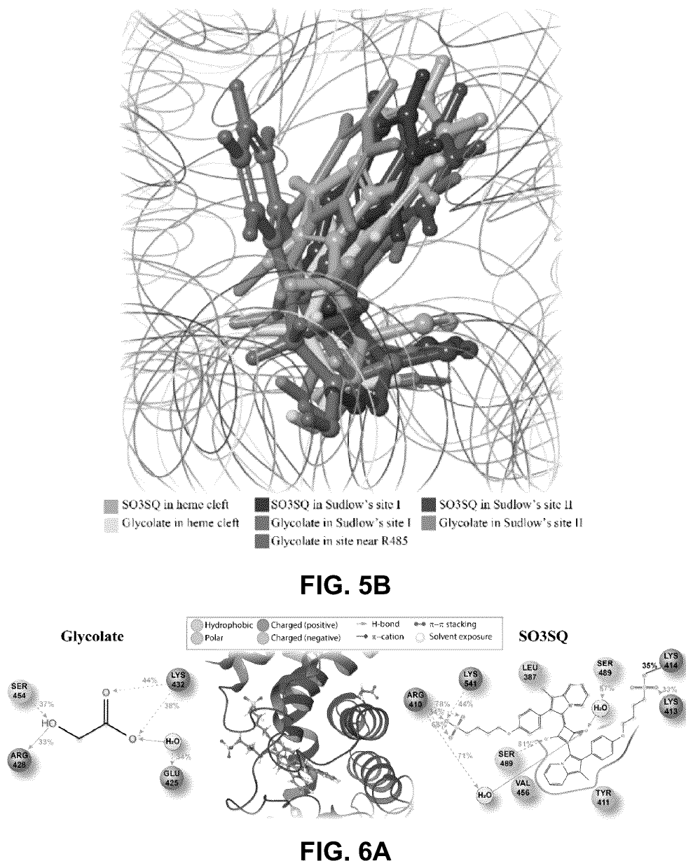

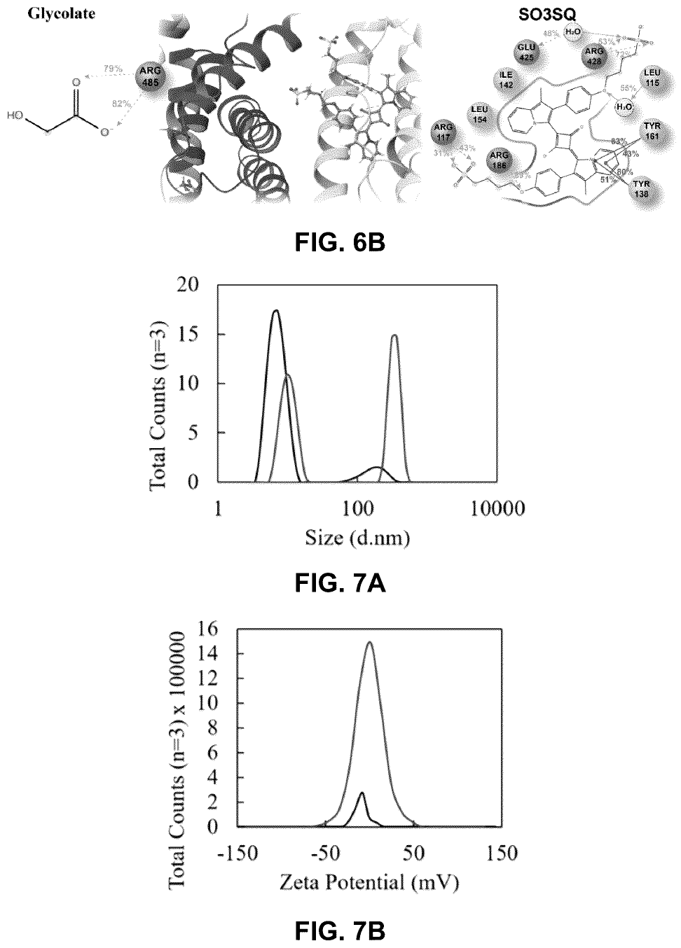

Previous work investigated the interaction between SO₃SQ dye and HSA. Here the mechanism of tryptophan fluorescence quenching and overall fluorescence increase when the IL is added to the SO₃SQ-HSA complex is investigated. Previous computational modeling revealed the heme cleft being the most favorable binding site with the dye. Additionally, it was shown that the dye's binding into Sudlow's sites I and II was possible after the saturation of the heme cleft, as suggested by the normalized plot of fluorescence intensity versus protein concentration. Hence for this work, all three binding sites are considered. Since ionic liquid components are relatively small compared to the HSA protein, they can bind to other binding sites of the HSA (fatty acid binding sites). However, only the above-mentioned drug-binding sites are considered for the model's simplicity. First, both the dye and the IL components were docked to HSA separately. Complexes obtained using molecular docking and MM/GBSA calculations were further subjected to MD simulation. During the 50 ns simulation, SO₃SQ bound to the heme cleft (FIG. 4A), and Sudlow's site I (FIG. 4B) retained the most significant number of interactions with the protein. When bound inside Sudlow's site 1, SO₃SQ formed a hydrogen bond and π-π and π-cation interactions with the tryptophan residue lasting about half of the simulation time. This binding could be a cause for the intrinsic fluorescence quenching of tryptophan residue within the protein, shown in the previous subsection. Even though more hydrogen bonds were formed for the case of Sudlow's Site 1, the complex of dye with the heme cleft showed an overall better binding pattern with more r-r and r-cation interactions and a more defined shape complementarity, sitting tighter inside of the binding pocket. Inside Sudlow's site II, the ligand was stabilized by only five H-bonds and exhibited a high level of solvent exposure (FIG. 4C). MD trajectories were further clustered, and the most populated cluster was used to repeat MM/GBSA calculations for more accurate free binding energy prediction (FIG. 4E). Refining of the dye's binding energy showed more negative binding energy when inside of the heme cleft (−108.18 kcal/mol), followed by Sudlow's site I (−69.05 kcal/mol) and Sudlow's site II (−64.04 kcal/mol). Molecular docking and MM/GBSA calculations demonstrated that the choline cation was a more potent binder for HSA compared to the glycolate anion with an average binding affinity toward all three binding sites of −28.45 kcal/mol (compared to −13.33 kcal/mol in the case of the glycolate). Further, a molecular dynamics simulation demonstrated that within 50 ns of a simulation time, choline left the binding pocket of the protein, unable to form any strong interactions. It is expected that MM/GBSA overestimates the binding affinity. In some cases, only a MD simulation can reveal whether the ligand can actually bind the protein, as was shown for the case study of cannabidiol interacting with CBR1. Considering the results of molecular dynamics, it is concluded that the anion of the ionic liquid (rather than the cation) plays a more important role in interacting with albumin, although the identity of the cation is still crucial (see FIG. 26). This conclusion is supported by previously published works. Initially, glycolate bound the strongest within the heme cleft (FIG. 4A), forming two H-bonds with R428 (93-94% of a simulation time) and four water bridges with E425 and K432. Docked into Sudlow's sites I and II (FIGS. 4B-4C), it retained H-bonds with K199 and R410, respectively, for about half of the simulation time. In both cases, closer to the end of the simulation time, glycolate migrated toward subunit IIIA (near Sudlow's site II) and bound to R484 and R485. Taking this into account, the last frames of trajectories were used for an additional 50 ns of MD simulations. Migrating from Sudlow's site I, after 22 ns of simulations, glycolate settled near residues R484 and R485. The ligands' RMSD aligned on protein did not exceed 1 Å. Glycolate formed strong H-bonds with R484, R485, and L481, sitting tightly within the positively charged pocket of the protein. The refined free binding energy for this binding site was −22.06 kcal/mol, exceeding the one predicted for the heme cleft. Overall, the strength of binding decreases in a row: a site near R485>heme cleft>Sudlow's site II >Sudlow's Site I (FIG. 4E). The binding of a dye or ionic liquid could indirectly influence the fluorescence of the tryptophan residue, triggering a quenching due to local changes near the interaction site or binding-induced conformational changes. Complexes of SO₃SQ-HSA and G-HSA, obtained by MD simulation followed by clustering and structure refinement with MM/GBSA, were aligned on the original protein structure. Deviations for these complexes varied from 2.5 to 3.5 Å and predominated in subunits IA and IB (FIGS. 5A-5B), which should not influence the properties of only one HSA's tryptophan residue (W214). However, when glycolate was bound in the IIIA subunit near residue R485, a noticeable change in the W214 position was observed (FIG. 5B). Thus, the quenching could presumably arise not only from the binding of a dye directly to W214 but also from a conformational change caused by association of HSA with ionic liquid. That explains the decrease in tryptophan fluorescence when ionic liquid was added to the albumin without the dye (FIG. 3C). Further, SO₃SQ-HSA and G-HSA complexes were used to mimic two scenarios used in fluorescence spectroscopy of the tryptophan residue of HSA. The first scenario simulated a case when SO₃SQ is already bound to albumin prior to the addition of IL (FIG. 3C), and the second one simulated a case when IL is added first, followed by the addition of SO₃SQ (FIG. 3D). For the six complexes of SO₃SQ and glycolate bound to three possible binding sites of HSA, a consequent binding of a dye or ionic liquid to three binding sites was simulated using molecular docking and MM/GBSA (Table 2). In the first scenario, when the dye is already associated with albumin, the affinity for the consequent binding of glycolate to the heme cleft increased (compared to the original −14.78 kcal/mol). In contrast, its binding to Sudlow's site I became less favorable (compared to the original −12.03 kcal/mol). Docking of glycolate into Sudlow's site II showed a noticeable increase in affinity toward HSA when SO₃SQ was in the heme cleft and did not change significantly for SO₃SQ complex bound to other binding sites. The second scenario showed considerably more complex trends. The binding of a dye into the heme cleft of the G-HSA complex was less favorable than its association with unbound HSA. SO₃SQ docked into Sudlow's site I showed increased affinity only when glycolate was present in Sudlow's Site 1l. The presence of glycolate in subunit IIIA near residues R484 and R485 appeared to decrease the overall binding affinity of a dye. The critical change in affinity was noticed for the dye binding into Sudlow's site II of HSA with glycolate in its heme cleft (an increase from −64.04 to −105.34 kcal/mol). Dye's binding to Sudlow's Site II was also increased by prior binding of glycolate to the same site. This implies that the presence of ionic liquid could improve the binding of SO₃SQ to Sudlow's Site 1l, thus, increasing the overall binding affinity in a dye-HSA complex. To test this presumption, a molecular dynamic simulation was carried out for SO₃SQ-IL-HSA complexes, intending to evaluate its stability. First, an increase in the affinity of the dye toward Sudlow's Site II of albumin in the presence of an ionic liquid was investigated. The complex with the highest affinity with glycolate being bound in heme cleft and SO₃SQ was in Sudlow's Site II and was subjected to a 100 ns MD simulation. At the beginning of the trajectory, a slight rearrangement of the glycolate position was observed. It migrated from the heme cleft to the IIIA subunit and further stabilized in it. Due to this rearrangement, it was more informative to analyze the last half of the trajectory when ligands have already settled. When comparing interactions formed by the dye in the absence of ionic liquid (FIG. 4C) and in its presence (FIG. 6A), the binding was more favorable in the latter case. Facilitated by the ionic liquid, SO₃SQ formed an overall larger number of H-bonds and an additional salt bridge with K414, and was less exposed to the solvent with one of the indolizine donors sitting tighter inside of the binding pocket of the protein. That could be caused by conformational changes in subunit Ill. Thus, one can presume that when an ionic liquid is added to the SO₃SQ-albumin solution, it enables the dye's attachment to binding sites that previously were not as favorable without an ionic liquid. Further, it was desirable to verify whether the presence of glycolate in Sudlow's Site II may cause a decrease in the binding affinity of the dye for the heme cleft. Like the previous simulation, at the beginning of the trajectory, glycolate migrated from the original binding pocket (FIG. 6B). By the second half of the trajectory, it bound to R485. Interactions of SO₃SQ with the albumin's heme cleft did not change significantly, except for the slight overall improvement, fewer π-cation interactions, and the larger number of H-bonds.

TABLE 2
Free Binding Energies Predicted by MM/GBSA Performed
after MD Simulation and Trajectory Clustering
Glycolate binds to HSA:

| Condition: | Heme cleft: | Sudlow's Site I | Sudlow's Site II |
|---|---|---|---|
| Unbound albumin | −14.78 | −12.03 | −13.17 |

Scenario I: glycolate binds to:

| | | | |
|---|---|---|---|
| SO₃SQ is in heme cleft | −16.38 | −9.75 | −23.99 |
| SO₃SQ is in Sudlow's Site I | −21.94 | −3.07 | −13.39 |
| SO₃SQ is in Sudlow's Site II | −19.23 | −4.85 | −12.82 |

Scenario II: SO₃SQ binds to:

| | | | |
|---|---|---|---|
| glycolate is in heme cleft | −87.54 | −61.26 | −105.34 |
| glycolate is in Sudlow's Site I | −92.93 | −68.39 | −51.35 |
| glycolate is in Sudlow's Site II | −91.83 | −74.59 | −74.76 |
| Glycolate is near R485 | −84.51 | −54.78 | −60.27 |

SO₃SQ binds to HSA:

| | | | |
|---|---|---|---|
| Unbound albumin | −108.18 | −69.05 | −64.04 |

### Dynamic Light Scattering (DLS)

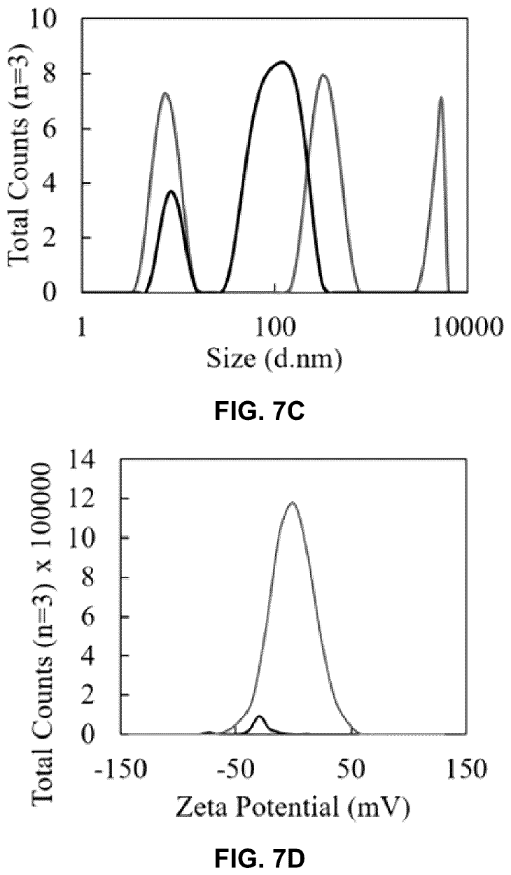

To further explore the potential formation of HSA-dye-IL complexes, dynamic light scattering (DLS) measurements were conducted. DLS measurements of the HSA systems with and without IL, either in water or 10 μM SO₃SQ, revealed the formation of complexes and aggregation. Controls of the SO₃SQ dye by itself, CG 1:1 by itself, and SO₃SQ with CG 1:1 in the absence of albumin were also measured with DLS (FIGS. 29-31B). In the system consisting of HSA in water, light scattering shows a bimodal distribution consisting of smaller complexes (˜8 nm) and larger aggregates (˜150 nm). When 160 mM 1:1 CG is added, it is incorporated into the HSA complex, as is evident by the sharp increase in the average size. CG 1:1 continues to form its own complexes in solution, which is shown by the sharper peak at −600 nm (FIG. 7A). The average size of the complex increases from 50±30 nm to 430±150 nm, although as can be seen in FIGS. 7A-7D, the distribution is bimodal. The zeta potential data of the system of HSA in water shows that the overall charge of the complex becomes slightly more positive upon the addition of IL, due to the stronger attraction of the cholinium cation of CG 1:1 to the outside of the complex, with its anion counterpart likely burrowed further in to the protein, as indicated by the tryptophan fluorescence and MD simulations in the previous sections (FIG. 7B). The average charge is −9.8±0.7 mV prior to the addition of the IL, while the IL increases the average charge of the overall system to −0.17±0.17 mV. For the system containing HSA in 10 μM SO₃SQ, the addition of 1:1 CG causes the HSA complex (at ˜8 nm) to decrease in size slightly while causing a significant increase in the size of the dye complex (˜100 nm) (FIG. 7C). Overall, the system as a whole shows a slight increase in average size upon the addition of CG 1:1, from 150±20 nm to 170±40 nm. When examining the zeta potential data, an overall increase in the average charge from −20±5 mV to −0.30±0.60 mV is seen due to the fact the IL is rearranging the dye/HSA complex in a way that leads to exposure of the choline cation (FIG. 7D).

### Isothermal Titration Calorimetry (ITC)

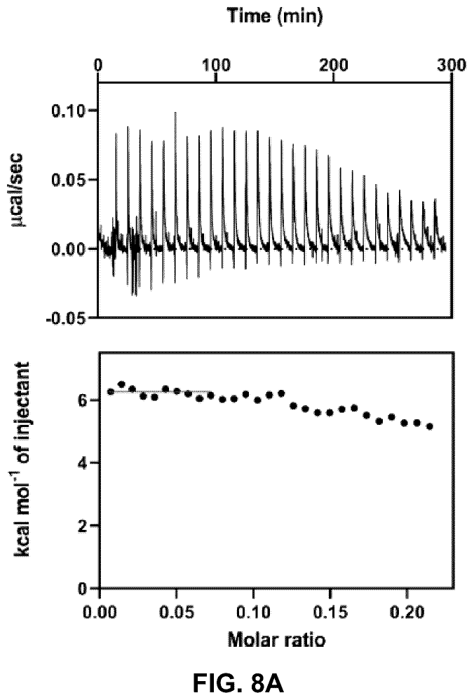

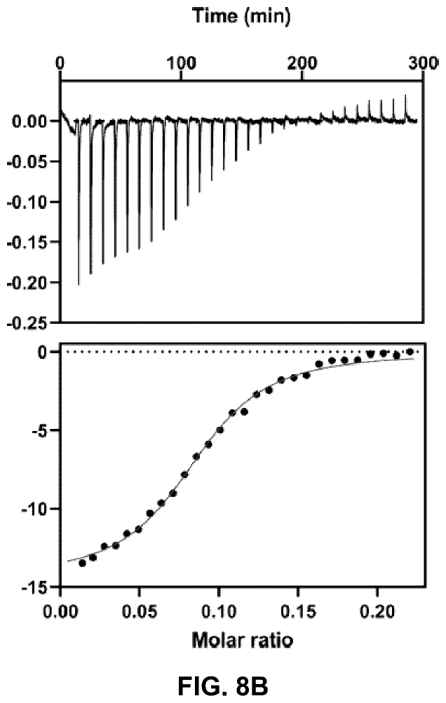

Isothermal titration calorimetry (ITC) was utilized next to further characterize the binding. Ionic liquids exhibit strong nonideality, and because of this, they produce significant heats of dilution in ITC measurements. A careful match between the syringe and the sample cell is needed to eliminate this effect. In this case, SO₃SQ also has limited aqueous solubility (˜60 μM), which limits the range of concentrations over which ITC can be performed. Low concentrations of dye are required, which reduces the detectable heat and affects the Wiseman c value. Here, substoichiometric concentrations of HSA were used, titrated into (SO₃SQ) in a reverse titration. Under these conditions, ΔH of binding is accessible, but K and N are not. It was found that the enthalpy of binding between HSA and SO₃SQ was positive, ΔH=6.1±0.2 kcal/mol in a buffer containing 40 mM ionic liquid. Interestingly, the behavior was different in the absence of 1:1 CG 1:1. A complete titration was observable in the reverse experiment, this time with an exothermic heat of binding (ΔH=−18±2 kcal mol⁻¹, K=(1.8±0.4)×10⁶, ΔG°=−8.50±0.13 kcal mol⁻¹, N=11.5±0.4; uncertainties are standard errors of the mean for three independent trials (FIGS. 8A-8B)). The positive sign of the enthalpy in the presence of an ionic liquid indicates that binding is entropically driven, which would be expected for a hydrophobic dye binding into a pocket on HSA, where binding is driven by the hydrophobic effect. Such entropy-driven binding to HSA has been observed for methylimidazole and amoxicillin binding. The fact that the enthalpy is exothermic in the absence of an ionic liquid suggests that the ionic liquid changes the behavior of the solvent, altering the mode of SO₃SQ binding. Work is ongoing to determine a more complete structural and thermodynamic characterization of the binding of SO₃SQ to HSA.

### Circular Dichroism (CD) Spectroscopy

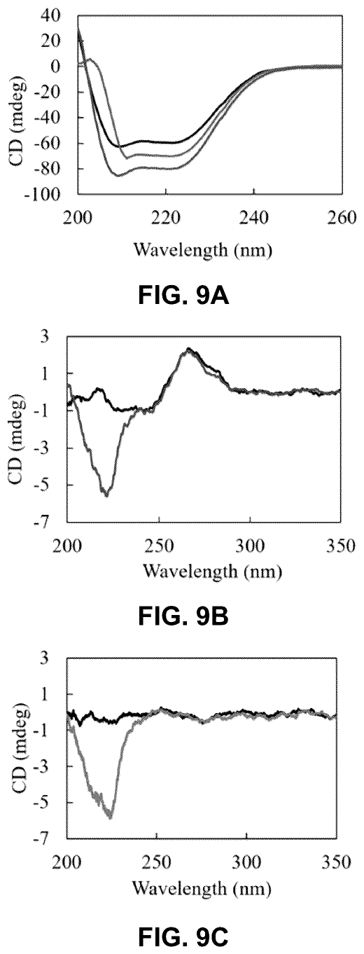

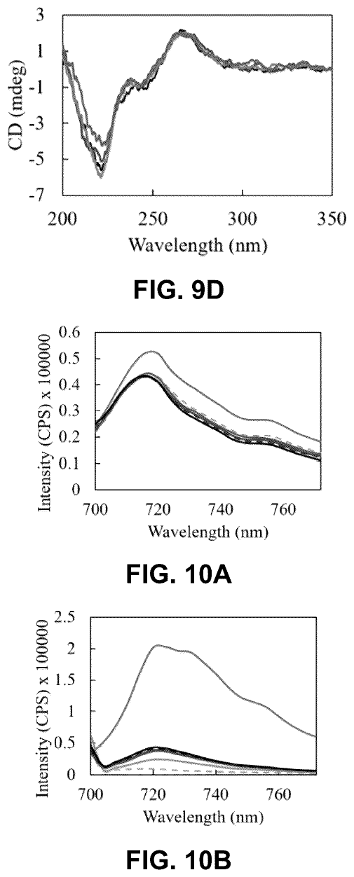

Finally, circular dichroism (CD) spectroscopy was used to test any impact this system may have on the secondary structures of HSA and DNA. When looking at the effect the dye and IL have on HSA (FIG. 9A), an increase in the alpha helical content of albumin is observed in a solution of 10 μM SO₃SQ, as well as in a solution of 10 μM SO₃SQ and 160 mM CG (1:1). This increase in the alpha helical content is a result of the initial binding of the protein as it is exposed to these systems; however, its secondary structure is still maintained. CD spectra were also obtained after exposing bacterial plasmid DNA to the test system (FIG. 9B). When the DNA is in 2.5% IL solution, the characteristic peaks of the synthetic plasmid DNA are still present at 245 and 265 nm, indicating limited structural changes to the DNA in the presence of the IL (FIG. 9B). Before the addition of plasmid DNA, no significant peaks are observed in the CD spectrum of 9.14 μM SO₃SQ dye in water (FIG. 9C). However, an apparent minimum peak at approximately 225 nm corresponding to the IL is observed in the CD spectrum of the SO₃SQ dye in a 2.5% IL solution (FIG. 9C). After 5 μL of 1 μM dye solution was added for a total of three times to DNA in 2.5% IL (FIG. 9D), no significant changes in the CD spectra were seen after each 5 μL addition. Notably, the peaks at 245 and 265 nm, both corresponding to the plasmid DNA's structure, indicate that the SO₃SQ/CG (1:1) causes limited or no structural changes to the DNA. The system's compatibility with albumin and DNA will allow samples that are subjected to it to undergo further protein analysis. This is desirable for future potential application to crime scene investigation, where the DNA obtained from a crime scene is likely to provide the most valuable information. Therefore, this test system must interact with albumin but also not interfere with the structure of DNA.

### CONCLUSIONS

Herein it has been determined that it is possible to manipulate the nanointeractions of a NIR dye and albumin through the addition of an IL to control its switch-on fluorescence in whole blood. Specifically, 160 mM of IL CG 1:1 resulted in a 5-fold “switch-on” increase in the SO₃SQ dye's fluorescence in the presence of blood, while suppressing the emission in the absence of blood. Through analysis of the dye's fluorescence in the presence of albumin with and without IL, it was determined that the SO₃SQ/HSA system with 160 mM CG 1:1 had a higher apparent binding association constant (KA,app=1.4×10⁶) than the system of just SO₃SQ/HSA (2.0×10⁵), thus lending to a more favored free energy of binding for the system with IL. Fluorescence spectroscopy was also used to monitor interactions with the tryptophan residue in the albumin in the presence of dye and/or IL, and a decrease in the emission was observed, suggesting an interaction between the IL, dye, and HSA. MD simulations suggest that the IL facilitates additional binding sites in the albumin, resulting in stronger interactions dominated by hydrogen bonding between the glycolate and the albumin. These simulations are supported by ITC measurements, which indicate a balance between entropic and enthalpic effects that can be modulated by the presence of CG. DLS data obtained for HSA in the presence of dye and/or ILs show an increase in both size and charge when IL is added, suggesting the formation of complexes. CD spectroscopy shows that the dye/IL system does not alter the secondary structures of either HSA or DNA, evidencing compatibility for potential further processing. This system therefore shows promise for the future development as a forensic stain, where high sensitivity to blood is paramount.

### Example 3: Ionic Liquid (IL) Characterization Data

A library of >50 biocompatible ionic liquids was designed and synthesized from commercially available starting materials, a subset of which is shown in FIG. 45. A particular focus on choline carboxylic acids and amino acids will be maintained. The synthesis of the ILs is achieved by combining a cation bicarbonate with an anion with a labile proton, which undergoes a salt metathesis to produce the ionic liquid (Scheme 2). Water and carbon dioxide are produced as byproducts, which can be removed by placing the ionic liquid into a rotary evaporator and drying it further in a vacuum oven. The identity of the ionic liquid can be confirmed using proton nuclear magnetic resonance spectroscopy.

### Choline Acetoxyacetate 1:1 (CAAA 1:1)

¹H NMR (400 MHz, d6-DMSO) δ 4.16 (s, 2H), 3.83 (h, J=2.6 Hz, 2H), 3.47-3.37 (m, 2H), 3.13 (s, 9H), 1.99 (s, 3H). Water Content: 2.57%.

### Choline Acetoxyacetate 1:2 (CAAA 1:2)

¹H NMR (400 MHz, d6-DMSO) δ 4.30 (s, 4H), 3.76 (s, 2H), 3.42 (s, 2H), 3.11 (s, 9H), 2.03 (s, 6H). Water Content: 0.99%.

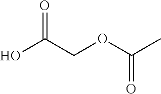

### Choline Glycolate 1:1 (CAGIy 1:1)

¹H NMR (400 MHz, D2O) δ 3.97 (dq, J=5.4, 2.7 Hz, 2H), 3.84 (s, 2H), 3.46-3.39 (m, 2H), 3.11 (s, 9H). Water Content: 1.17%.

### Choline Glycolate 1:2 (CAGIy 1:2)

¹H NMR (400 MHz, d6-DMSO) δ 3.90 (dt, J=5.6, 2.7 Hz, 2H), 3.78 (s, 4H), 3.48 (dd, J=6.1, 4.2 Hz, 2H), 3.18 (s, 9H). Water Content: 2.73%.

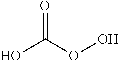

### Choline Hexanoate 1:1 (CAHA 1:1)

¹H NMR (400 MHz, d6-DMSO) δ 3.84 (dt, J=7.4, 2.7 Hz, 2H), 3.49-3.42 (m, 2H), 3.16 (s, 9H), 1.87 (t, J=7.5 Hz, 2H), 1.41 (p, J=7.4 Hz, 2H), 1.27-1.15 (m, 4H), 0.83 (td, J=7.1, 1.8 Hz, 3H). Water Content: 0.86%.

### Choline Hexanoate 1:2 (CAHA 1:2)

¹H NMR (400 MHz, d6-DMSO) δ 3.84 (td, J=5.6, 2.6 Hz, 2H), 3.44 (dq, J=7.5, 3.7 Hz, 2H), 3.14 (dd, J=5.9, 2.8 Hz, 9H), 2.05 (dt, J=9.1, 4.5 Hz, 4H), 1.45 (p, J=7.3 Hz, 4H), 1.23 (pd, J=8.4, 7.9, 2.9 Hz, 8H), 0.88-0.80 (m, 6H). Water Content: 2.74%.

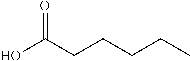

### Choline Octanoate 1:1 (CAOA 1:1)

¹H NMR (400 MHz, d6-DMSO) δ 3.85 (dq, J=8.1, 2.8 Hz, 2H), 3.46-3.39 (m, 6H), 3.13 (s, 9H), 1.82 (t, J=7.4 Hz, 2H), 1.40 (q, J=7.3 Hz, 2H), 1.23 (qd, J=12.4, 11.2, 7.1 Hz, 9H), 0.86 (t, J=6.9 Hz, 3H). Water Content: 1.25%.

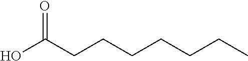

### Choline Pentanoate 1:1 (CAPA 1:1)

¹H NMR (400 MHz, d6-DMSO) δ 3.85 (dq, J=8.0, 2.8 Hz, 2H), 3.46-3.34 (m, 2H), 3.13 (s, 9H), 1.91-1.81 (m, 2H), 1.39 (tt, J=7.8, 6.5 Hz, 2H), 1.29-1.15 (m, 2H), 0.83 (t, J=7.3 Hz, 3H). Water Content: 0.64%.

### Choline Pentanoate 1:2 (CAPA 1:2)

¹H NMR (400 MHz, d6-DMSO) δ 3.89-3.80 (m, 2H), 3.45-3.38 (m, 2H), 3.12 (s, 9H), 2.01 (t, J=7.4 Hz, 4H), 1.48-1.36 (m, 4H), 1.31-1.17 (m, 4H), 0.84 (t, J=7.3 Hz, 6H). Water Content: 0.84%.

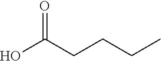

### Choline 3-Octenoate 1:1 (CA30E 1:1)

¹H NMR (400 MHz, d6-DMSO) δ 5.59-5.47 (m, 1H), 5.17 (dt, J=14.7, 6.7 Hz, 1H), 3.83 (dd, J=6.2, 3.7 Hz, 2H), 3.11 (s, 9H), 2.09 (s, 2H), 1.92 (d, J=6.9 Hz, 2H), 1.28 (q, J=5.1, 3.4 Hz, 4H), 0.90-0.82 (m, 3H). Water Content: 2.01%.

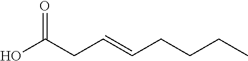

### Choline Heptanoate 1:2 (CAHPA 1:2)

¹H NMR (400 MHz, d6-DMSO) δ 3.84 (dq, J=5.4, 2.7 Hz, 2H), 3.43-3.38 (m, 2H), 3.11 (s, 9H), 2.02 (ddd, J=7.4, 5.9, 1.5 Hz, 4H), 1.42 (d, J=7.3 Hz, 5H), 1.31-1.17 (m, 13H), 0.85 (t, J=6.8 Hz, 6H). Water Content: 1.55%.

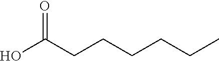

### Choline 2-Methyl-2-Butenoate 1:1 (CA2M2BE 1:1)

¹H NMR (400 MHz, d6-DMSO) δ 6.32 (q, J=6.9 Hz, 1H), 3.84 (h, J=2.6 Hz, 2H), 3.46 (dd, J=6.4, 3.7 Hz, 2H), 3.15 (s, 9H), 1.66 (s, 3H), 1.58 (d, J=7.2 Hz, 3H). Water Content: 6.20%.

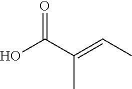

### Choline 3-Methyl Butanoate 1:1 (CA3MBE 1:1)

¹H NMR (400 MHz, d6-DMSO) δ 3.90-3.82 (m, 2H), 3.47-3.40 (m, 2H), 3.13 (s, 9H), 1.88 (ddt, J=14.1, 13.2, 6.7 Hz, 1H), 1.73 (d, J=7.0 Hz, 2H), 0.82 (d, J=6.6 Hz, 6H). Water Content: 6.13%.

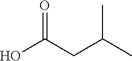

### Choline Lactate 1:1 (CALac 1:1)

¹H NMR (300 MHz, d6-DMSO) δ 3.91-3.80 (m, 2H), 3.45-3.39 (m, 2H), 3.13 (s, 9H), 1.31-1.20 (m, 1H), 1.08 (d, J=6.7 Hz, 3H). Water Content: 4.98%.

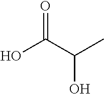

### Choline Butanoate 1:2 (CABA 1:2)

¹H NMR (400 MHz, d6-DMSO) δ 3.84 (dq, J=5.4, 2.6 Hz, 2H), 3.42 (dq, J=4.7, 2.6 Hz, 2H), 3.12 (s, 9H), 2.04 (ddd, J=7.8, 4.9, 3.0 Hz, 4H), 1.46 (h, J=7.3 Hz, 4H), 0.84 (td, J=7.4, 1.7 Hz, 6H). Water Content: 1.29%.

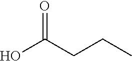

### Choline Levulinate 1:1 (CALev 1:1)

¹H NMR (400 MHz, d6-DMSO) δ 3.84 (dq, J=5.6, 2.7 Hz, 2H), 3.42 (dd, J=6.1, 3.8 Hz, 2H), 3.13 (s, 9H), 2.49 (t, J=6.9 Hz, 2H), 2.14 (t, J=6.9 Hz, 2H), 2.06 (s, 3H). Water Content: 3.31%.

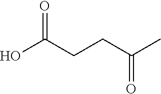

### Choline 2-Butenoate 1:1 (CA2BE 1:1)

¹H NMR (400 MHz, d6-DMSO) δ 6.30 (dtd, J=13.7, 6.9, 3.0 Hz, 1H), 5.67 (dd, J=15.2, 2.1 Hz, 2H), 3.83 (q, J=4.1 Hz, 2H), 3.49-3.42 (m, 2H), 3.15 (s, 9H), 1.66 (d, J=7.0 Hz, 3H). Water Content: 4.03%.

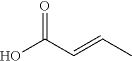

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Afrin, S.; et al. Spectroscopic and Calorimetric Studies of Interaction of Methimazole with Human Serum Albumin. J. Lumin. 2014, 151, 219-223.
2. Akdogan, Y.; et al. Effect of Ionic Liquids on the Solution Structure of Human Serum Albumin.

### Biomacromolecules 2011, 12 (4), 1072-1079.

3. Belatik, A.; et al. Locating the binding sites of Pb(II) ion with human and bovine serum albumins. PLoS One. 2012, 7 (5), e36723.
4. Burstein, E. A.; et al. FLUORESCENCE AND THE LOCATION OF TRYPTOPHAN RESIDUES IN PROTEIN MOLECULES. Photochem. Photobiol. 1973, 18, 263-279.
5. Chandran, A.; et al. Groove Binding Mechanism of Ionic Liquids: A Key Factor in Long-Term Stability of DNA in Hydrated Ionic Liquids? J. Am. Chem. Soc. 2012, 134 (50), 20330-20339.
6. Chism, C. M.; et al. Antimicrobial Effects of Anion Manipulation with Biocompatible Choline Carboxylic Acid-Based Ionic Liquids. ACS Applied Engineering Materials 2023, 1, 23.
7. Egorova, K. S.; et al. Ionic Liquids: Prospects for Nucleic Acid Handling and Delivery. Nucleic Acids Res. 2021, 49, 1201-1234.
8. Figueiredo, A. M.; Set al. Protein Destabilisation in Ionic Liquids: The Role of Preferential Interactions in Denaturation. Phys. Chem. Chem. Phys. 2013, 15 (45), 19632-19643.
9. Jaeger, V. W.; et al. Destabilization of Human Serum Albumin by Ionic Liquids Studied Using Enhanced Molecular Dynamics Simulations. J. Phys. Chem. B 2016, 120 (47), 12079-12087.
10. Kowalska, D.; et al. Interaction of Ionic Liquids with Human Serum Albumin in the View of Bioconcentration: A Preliminary Study. Chemical Papers 2022, 76 (4), 2405-2417.
11. Kumar, S.; et al How Does Cholinium Cation Surpass Tetraethylammonium Cation in Amino Acid-Based Ionic Liquids for Thermal and Structural Stability of Serum Albumins? Int. J. Biol. Macromol. 2020, 148, 615-626.
12. Le, V. H.; et al. Modeling Complex Equilibria in Isothermal Titration Calorimetry Experiments: Thermodynamic Parameters Estimation for a Three-Binding-Site Model. Anal. Biochem. 2013, 434 (2), 233-241.
13. Levitus, M. Tutorial: measurement of fluorescence spectra and determination of relative fluorescence quantum yields of transparent samples. Methods Appl. Fluoresc 2020, 8 (3), 033001.
14. Lewis, E. A.; et al. Isothermal Titration Calorimetry. Methods Mol. Biol. 2005, 305, 1-16.
15. Meador, W. E.; et al. Ultra-Bright Near-Infrared Sulfonate-Indolizine Cyanine- and Squaraine-Albumin Chaperones: Record Quantum Yields and Applications. ChemPhotoChem 2022, 6 (9), e202200127.
16. Meador, W. E.; et al. Water-Soluble NIR Absorbing and Emitting Indolizine Cyanine and Indolizine Squaraine Dyes for Biological Imaging. J. Org. Chem. 2020, 85 (6), 4089-4095.
17. Reddy, R. R.; et al. Selective Binding and Dynamics of Imidazole Alkyl Sulfate Ionic Liquids with Human Serum Albumin and Collagen-a Detailed NMR Investigation. Phys. Chem. Chem. Phys. 2018, 20 (14), 9256-9268.
18. Shu, Y.; et al. New Insight into Molecular Interactions of Imidazolium Ionic Liquids with Bovine Serum Albumin. J. Phys. Chem. B 2011, 115 (42), 12306-12314.
19. Shukla, S. K.; et al. Use of Ionic Liquids in Protein and DNA Chemistry. Frontiers in Chemistry 2020, 8, 598662.
20. Sindhu, A.; et al. Implications of Imidazolium-Based Ionic Liquids as Refolding Additives for Urea-Induced Denatured Serum Albumins. ACS Sustain Chem. Eng. 2020, 8 (1), 604-612.
21. Singh, G.; et al. Aqueous Colloidal Systems of Bovine Serum Albumin and Functionalized Surface Active Ionic Liquids for Material Transport. RSC Adv. 2020, 10 (12), 7073-7082.
22. Singh, T.; et al. Ionic Liquids Induced Structural Changes of Bovine Serum Albumin in Aqueous Media: A Detailed Physicochemical and Spectroscopic Study. J. Phys. Chem. B 2012, 116 (39), 11924-11935.
23. Tanner, E.; et al. The Influence of Water on Choline-Based Ionic Liquids. ACS Biomaterials Science and Engineering 2019, 5 (7), 3645-3653.
24. Tsuzuki, S.; et al. Magnitude and Directionality of Interaction in Ion Pairs of Ionic Liquids. Relationship with Ionic Conductivity. J. Phys. Chem. B 2005, 109 (34), 16474-16481.
25. Velazquez-Campoy, A.; et al. Isothermal Titration Calorimetry to Determine Association Constants for High-Affinity Ligands. Nature Protocols 2006 1:1 2006, 1 (1), 186-191.
26. Wang, X.; et al. The Anion of Choline-based Ionic Liquids Tailored Interactions Between Ionic Liquids and Bovine Serum Albumin, MCF-7 Cells, and Bacteria. Colloids and Surfaces B: Bio interfaces 2021, 206, 111971.
27. Wiseman, T.; et al. Rapid Measurement of Binding Constants and Heats of Binding Using a New Titration Calorimeter. Anal. Biochem. 1989, 179, 131.
28. Yasmeen, S.; et al. Calorimetric and Spectroscopic Binding Studies of Amoxicillin with Human Serum Albumin. Journal of Thermal Analysis and Calorimetry 2016 127:2 2017, 127 (2), 1445-1455.

What is claimed is:

1. A composition for determining whether a substance is blood, the composition comprising an ionic liquid and a near infrared (NIR) dye in an aqueous solution.

2. The composition of claim 1, wherein the NIR dye comprises an indolizine-donor based squaraine dye.

3. The composition of claim 2, wherein the NIR dye comprises SO₃SQ.

4. The composition of claim 1, wherein the ionic liquid comprises a choline cation and an anion selected from acetoxyacetate, glycolate, hexanoate, octanoate, pentanoate, 3-octenoate, heptanoate, 2-methyl-2-butenoate, 3-methyl butanoate, lactate, butanoate, levulinate, 2-butenoate, or any combination thereof.

5. The composition of claim 4, wherein the ionic liquid comprises a cation to anion ratio of from 1:1 to 1:2.

6. The composition of claim 4, wherein the ionic liquid is choline glycolate having a ratio of choline to glycolate of 1:1.

7. The composition of claim 1, wherein the ionic liquid is present in a concentration of from about 40 mM to about 240 mM.

8. The composition claim 1, wherein the NIR dye is present in a concentration of about 10 μM.

9. The composition of claim 1, wherein the composition remains stable during storage for at least 2 months at a temperature of from about 4° C. to about 25° C.

10. The composition of claim 1, wherein the composition binds preferentially to human serum albumin (HSA) over other mammalian serum albumin proteins.

11. A method for determining whether a substance is blood, the method comprising contacting the substance with the composition of claim 1 and visualizing the substance.

12. The method of claim 11, wherein the substance is in aqueous solution and visualizing the substance is carried out by fluorescence spectroscopy.

13. The method of claim 12, wherein an excitation wavelength of about 690 nm is used to visualize the substance, and wherein emission is observed at from about 700 to about 772 nm.

14. The method of claim 11, wherein performing the method does not degrade or damage any DNA present in the substance.

15. A method for increasing a fluorescence quantum yield of an indolizine-donor based squaraine dye, the method comprising contacting an aqueous composition comprising the dye and an ionic liquid with human serum albumin.

16. The method of claim 15, wherein the dye comprises SO₃SQ.

17. The method of claim 15, wherein the ionic liquid comprises a choline cation and an anion selected from acetoxyacetate, glycolate, hexanoate, octanoate, pentanoate, 3-octenoate, heptanoate, 2-methyl-2-butenoate, 3-methyl butanoate, lactate, butanoate, levulinate, 2-butenoate, or any combination thereof.

18. The method of claim 17, wherein the ionic liquid comprises a cation to anion ratio of from 1:1 to 1:2.

19. The method of claim 17, wherein the ionic liquid is choline glycolate having a ratio of choline to glycolate of 1:1.

20. The method of claim 15, wherein the increase in fluorescence quantum yield (Φ_{f}) is at least 4×.
